(19) United States
(12) Patent Application Publication
(10) Pub. No.: US 2009/0259013 A1
(43) Pub. Date: Oct. 15, 2009

(54) LIQUID CRYSTAL POLY(PHENYLENE DISULFONIC ACIDS)

(76) Inventors: Morton H. Litt, University Heights, OH (US); Junwon Kang, Seoul (KR)

Correspondence Address: TAROLLI, SUNDHEIM, COVELL & TUMMINO, LLP, 1300 EAST NINTH STREET, SUITE 1700, CLEVELAND, OH, 44114, US

(21) Appl. No.: 12/408,402

(22) Filed: Mar. 20, 2009

Related U.S. Application Data
(60) Provisional application No. 61/038,186, filed on Mar. 20, 2008.

(51) Int. Cl. C08G 75/00

(52) U.S. Cl. 528/174; 528/171

(57) ABSTRACT

A rigid, rod liquid crystal polymer includes a poly(phenylene disulfonic acid).

### RELATED APPLICATION

This application claims priority from U.S. Provisional Application No. 61/038,186, filed Mar. 20, 2008, the subject matter, which is incorporated herein by reference in its entirety.

### TECHNICAL FIELD

The present invention relates to a polymeric material, and more particularly, to a rigid, rod liquid crystal polymer.

### BACKGROUND OF THE INVENTION

A polymer electrolyte membrane (PEM) fuel cell (or proton exchange membrane fuel cell) includes a polymer electrolyte membrane that separates an anode compartment, where oxidation of a fuel occurs, and a cathode compartment, where reduction of an oxidizer occurs. The anode and cathode are essentially constituted by a porous support, such as a porous carbon support, on which particles of a noble metal (e.g., platinum) are deposited. The PEM provides a conduction medium for protons from the anode to the cathode as well as providing a barrier between the fuel and the oxidizer.

The polymer used to form the PEM should fulfill a number of conditions relating to mechanical, physio-chemical, and electrical properties. First, the polymer should exhibit ion exchange properties that allow sufficient conductivities to be achieved between the anode and cathode. For example, the polymer should exhibit a conductivity of at least about 0.05 mS/cm at operating conditions. In addition, the polymer should exhibit high chemical, dimensional, and mechanical stability during preparation and under extreme operating conditions, which are typically encountered in many fuel cell applications. For example, the polymer used to form the PEM should allow essentially no permeation of the fuels used in the fuel cell through the PEM. Moreover, it is desirable that the polymer used to form the PEM should be essentially water insoluble and resistant to swelling.

The polymer most widely used as a PEM for the manufacturing a fuel cell is NAFION, which is commercially available from DuPont. Polymers of NAFION are typically obtained by the co-polymerization of two fluorinated monomers, one of which carries a sulfonic acid (SO₃H) group after hydrolysis. NAFION is adequate for use in many current fuel cell applications, but exhibits several deficiencies. NAFION exhibits structural instability at temperatures above 100° C. Moreover, NAFION has poor conductivity at low relative humidity and cannot readily be used at temperatures above 80° C. because it dries out. Furthermore, NAFION exhibits high osmotic drag, which contributes to difficulties in water management at high current densities. In addition, high methanol permeability in NAFION contributes to detrimental fuel cross over, in which fuel passes across the anode, through the NAFION membrane and to the cathode. Consequently, in instances of fuel cross over, methanol is oxidized at the cathode and fuel cell efficiency decreases.

### SUMMARY OF THE INVENTION

The present invention relates to a rigid-rod liquid crystal polymer that can be used to form a polymer electrolyte membrane (PEM) or an ion exchange membrane. The liquid crystal polymer, in accordance with the present invention, can include a plurality of phenylene disulfonic acid repeating units that are linked together to form a substantial portion of a main chain or backbone of the liquid crystal polymer. The phenylene disulfonic acid repeating units together form calamitic mesogen units that make up a substantial portion of the liquid crystal polymer.

Rigid, rod liquid crystal polymers in accordance with the present invention can organize as nematic liquid crystals. They can also form aggregates or micelles that have a substantially planar structure with sulfonic acid groups extending from the planar structure. This provides opportunities to modify properties of the liquid crystal polymer, such as free volume water retention and conductivity, by small changes in the liquid crystal polymer structure.

The liquid crystal polymers in accordance with the present invention can comprise a homopolymer or copolymer. In accordance with one aspect of the present invention, the liquid crystal polymer can comprise a homopolymer that includes a phenylene disulfonic acid mesogen repeating unit. One example of a homopolymer comprising a phenylene disulfonic acid repeating unit is shown below as structure I.

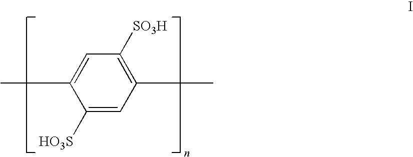

wherein n is at least 1.

The poly(phenylene disulfonic acids) can be formed from any dihalo-monocylic or polycylic aryl disulfonic acid monomer that once polymerized or copolymerized comprises a substantial portion of the polymer main chain or backbone and is linear enough to form a liquid crystal. Examples of dihalo-monocyclic or polycyclic aryl disulfonic acids that can be used to form the poly(phenylene disulfonic acids) include dihalo-benzene disulfonic acids and dihalo-biphenyl tetrasulfonic acids. It will be appreciated that other dihalo monocyclic or polycyclic aryl hydrocarbons can also be used.

In an aspect of the invention the dihalo-monocylic or polycyclic aryl disulfonic acid monomer can be polymerized via an Ullmann coupling reaction to form the liquid crystal polymer or copolymer. The sulfonic acid groups of dihalo-monocylic or polycyclic aryl disulfonic acid monomer can be provided as sulfonate salts with counterions to enhance the solubility of the monomers during polymerization. Any counterion that is stable under reaction conditions and keeps the polymer soluble can be used.

In accordance with yet another aspect, the liquid crystal polymers of the present invention can comprise a hydrolytically stable poly(phenylene disulfonic acid) copolymer that includes at least one of random, graded, or block repeating units of phenylene disulfonic acid and a second repeating unit that includes a non-polar aryl group.

One example of the of a hydrolytically stable poly(phenylene disulfonic acid) copolymer comprises a phenylene disulfonic acid repeating unit and a second repeating unit R₁ that contains non-polar aryl repeating groups depicted as follows:

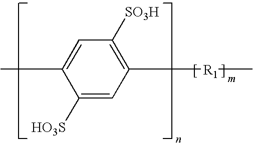

wherein n is at least 1.

The second repeating unit can be formed from a non-polar aryl comonomer that can increase the frozen-in free volume and make the polymer dimensionally stable in water.

The present invention also relates to methods and processes of forming the poly(phenylene disulfonic acid) homopolymers and copolymers as well as the comonomers used to form the poly(phenylene disulfonic acid) copolymers.

### BRIEF DESCRIPTION OF THE DRAWINGS

Further features of the present invention will become apparent to those skilled in the art to which the present invention relates from reading the following description of the invention with reference to the accompanying drawings.

FIG. 1 illustrates rheograms for aqueous PPDSA (lot 3, high molecular weight polymer) solutions at different concentrations and shear rates.

FIG. 2 illustrates reduced viscosities as a function of concentration for different salt forms of PPDSA (lots 1, 2 and 3) in different solvents at 35° C.

FIG. 3 illustrates reduced viscosities of PPDSA, diprotonated (lot 3, high molecular weight polymer) in D.I. water at 35° C. using different viscometers.

FIG. 4 illustrates the effect of salt concentration on reduced viscosities of PPDSA (lot 2) in DMF.

FIG. 5 illustrates the effect of solvent on the reduced viscosity of PPDSA (lot 2).

FIG. 6 illustrates the effect of PPDSA counterion on reduced viscosities of PPDSA (lot 1).

FIG. 7 illustrates lambda (λ) of PPDSA films as a function of relative humidity. Lot 2 PPDSA had higher molecular weight than lot 1.

FIG. 8 illustrates plots of dimensional changes of PPDSA film (lot 2) vs. relative humidity.

FIG. 9 illustrates DSC thermograms for melting of a) bulk water and b) absorbed water in equilibrated PPDSA films (lot 3, high molecular weight polymer) at different humidities.

FIG. 10 illustrates DSC thermograms for vaporization of a) bulk water and b) absorbed water in equilibrated PPDSA films (lot 3, high molecular weight polymer) at different humidities.

FIG. 11 illustrates WAXD diffractograms in transmission mode of PPDSA (lot 2).

FIG. 12 illustrates WAXD diffractograms in reflection mode of PPDSA (lot 2).

FIG. 13 illustrates 2D X-ray diffraction images of PPDSA (lot 2) at different relative humidities.

FIG. 14 illustrates an OPM image of PPDSA (lot 3, high molecular weight polymer aqueous solution (38.51 g/dL) (X100) under cross-polarized light.

FIG. 15 illustrates proton conductivities of PPDSA film from different lots at different relative humidities and temperatures.

FIG. 16 illustrates the effect of the casting direction vs. measuring direction on conductivity. a) lot 2, and b) lot 3 (high molecular weight polymer).

FIG. 17 illustrates lambda (λ) of PPDSA films and Nafion 117 as a function of relative humidity.

FIG. 18 illustrates a plot of d spacing vs. lambda for peak A at different humidities (0 to 75% RH).

FIG. 19 illustrates the proton conductivities of PPDSA film of different lots at different conditions.

FIG. 20 illustrates the ln[σ (conductivity)] plot for PPDSA strips (lot 2) as a function of temperature (1/T).

FIG. 21 illustrates corrected and uncorrected conductivities of PPDSA film (lot 2) using a) parallel and (b) perpendicular cut films to the casting direction.

FIG. 22 illustrates a comparison of the intrinsic conductivities and the measured conductivities for PPDSA film (lot 2) with a) parallel and (b) perpendicular cut films to the casting direction.

### DETAILED DESCRIPTION

The present invention relates to polymers that can be used to form a polymer electrolyte membrane (PEM) or an ion exchange membrane. The electrolyte membrane can be particularly adapted for use in a fuel cell, liquid-ion separation, gaseous diffusion, reverse osmosis, as well as electrochemical applications, such as electroplating, electrolysis, and electrodialysis.

The polymers in accordance with the present invention are rigid, rod liquid crystal polymers. The term “liquid crystal” as used herein refers to a state in which the polymer molecules exhibit a certain degree of orientational order, between crystalline and amorphous states. In solution, molecules according to a preferred embodiment of the present invention are locally parallel above a low concentration but are still generally free to diffuse about. But, when in the form of a solid membrane, the molecules are generally fixed in place and exhibit some degree of liquid crystal order. This is particularly evident upon application of a deforming load to the membrane. During the evaporation of solvent from a solution of the polymer in accordance with the present invention, the molecules attain their orientation and are considered liquid crystalline. Molecules demonstrating such characteristics are said to be lyotropic liquid crystals.

A liquid crystal polymer in accordance with the present invention can include a plurality of phenylene disulfonic acid repeating units that are linked together to form a substantial portion of the main chain or backbone of the liquid crystal polymer. The phenylene disulfonic acid repeating units together form calamitic mesogen units that make up a substantial portion of the liquid crystal polymer.

The liquid crystal polymer in accordance with the present invention can comprise a homopolymer or copolymer. The copolymer can have a backbone (or chain) that comprises blocks or sequences of the phenylene disulfonic acid repeating units. The blocks or sequences of aromatic repeating units can be linked together with other blocks or sequences of aromatic repeating units to form random, graded, or block copolymers. These other blocks or sequences of aromatic repeating units can be non-polar and can comprise, for example, about 5% to about 10% of the polymer. In addition, the liquid crystal polymer can include copolymers of phenylene disulfonic acid, biphenylene disulfonic, and non-polar blocks or co-monomers.

In accordance with one aspect of the present invention, the liquid crystal polymer can comprise a homopolymer that includes a phenylene disulfonic acid mesogen repeating unit. An example of a liquid crystal polymer in accordance with this aspect of the invention comprises a phenylene disulfonic acid repeating unit, as shown in structure I.

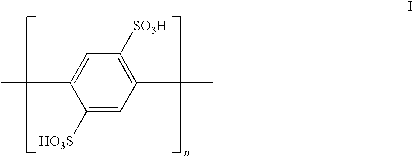

wherein n is at least 1.

The poly(phenylene disulfonic acids) depicted by structure I can be formed from 1,4-dihalo-2,5-benzenedisulfonic acids. Examples of 1,4-dihalo-2,5-benzenedisulfonic acids that can be used to form the poly(phenylene disulfonic acid) depicted by structure I can include 1,4-dibromo-2,5-benzenedisulfonic acids, 1,4-diiodo-2,5-benzenedisulfonic acids, and 1,4-dichloro-2,5-benzenedisulfonic acids.

In one method, the 1,4-dihalo-2,5-benzenedisulfonic acids can be synthesized from 1,4-dihalo-benzene by reacting the 1,4-dihalo-benzene in the presence of fuming sulfuric acid at a temperature of about 220° C. to about 230° C. for about 24 hours. The 1,4-dihalo-2,5-benzenedisulfonic acids can be polymerized using, for example, an Ullmann coupling reaction. In an Ullmann coupling reaction, 1,4-dihalo-2,5-benzendisulfonates formed from the 1,4-dihalo-2,5-benzenedisulfonic acids are coupled in the presence of a copper catalyst.

Other approaches can also be used to polymerize 1,4-dihalo-2,5-benzenedisulfonic acids as long as these other approaches avoid adversely affecting the sulfonic groups. Examples of these other approaches can include using different coupling reagents or catalysts, such as palladium (Pd), nickel (Ni), or nickel/zinc (Ni(0)/Zn), which are disclosed in Lemaire et al., Aryl-Aryl Bond Formation One Century After the Discovery of the Ullmann Reaction, Chem. Rev. 2002, 102, 1359-1469, herein incorporated by reference. It will also be appreciated that yet other approaches can be used to polymerize the dihalo-biphenyldisulfonic acids.

It will be appreciated that the poly(phenylene disulfonic acids) in accordance with the present invention can be formed from any dihalo-monocylic or polycylic aryl disulfonic acid monomer that once polymerized or copolymerized comprises a substantial portion of the polymer main chain or backbone and is linear enough to form a liquid crystal. Examples of other dihalo-monocyclic or polycyclic aryl sulfonic acid monomers, besides 1,4-dihalo-2,5-benzendisulfonic acids, that can be used to form the poly(phenylenedisulfonic acids) include dihalo-biphenyl tetrasulfonic acids, dihalo-triphenylhexasulfonic acids, dihalo-triphenydisulfonic acids, 1,4- or 1,5-dihalo naphthalene, 1,4-dihalo anthracene and/or anthraquinone disulfonic acids. It will be appreciated that other dihalo monocyclic or polycyclic aryl hydrocarbons can also be used.

Homopolymers and copolymers of the poly(phenylene disulfonic acids) can be cast as films from water and/or a variety of polar organic solvents. This allows the homopolymers or copolymers to be directly cast on electrodes as PEMs in membrane electrode assembly (MEA) processing for lower power micro-fuel cells. These polyelectrolyte membranes can have proton conductivities of about 100 times higher than NAFION 117 between about 15% relative humidity and room temperature, reaching 0.12 S/cm at 75% relative humidity and room temperature. In one example, the proton conductivity at 15% relative humidity and 75° C. was 0.1 S/cm, which is remarkably high compared to the proton conductivity of NAFION and any other sulfonic acid polyelectrolyte. Additionally, the poly(phenylenedisulfonic acid) is thermally stable with a decomposition temperature of about 295° C.

The liquid crystal polymers in accordance with the present invention can also comprise poly(phenylene disulfonic acids) that are chemically modified to incorporate bulky side groups and/or cross-linkable groups. The bulky side groups and/or cross-linkable groups can improve the dimensional stability of the poly(phenylene disulfonic acids) and render the poly(phenylenedisulfonic acids) substantially water insoluble.

The bulky and/or cross-linkable side groups can be incorporated into the poly(phenylenedisulfonic acid) backbone via a sulfone or sulfonate ester formation reaction to form a poly(phenylene disulfonic acid) copolymer, as shown below.

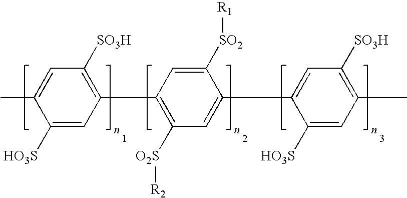

where R₁ and/or R₂ can each comprise a hydroxyl, a bulky group (e.g., di-(tert-butyl)hydroxyphenyl) and/or a cross-linkable group (e.g., biphenyl), and at least one R₁ or R₂ is not a hydroxyl and n, n₂, and n₃ are at least 1.

The mole fraction of R₁ and/or R₂ groups incorporated into the backbone of the polymer chain can range, for example, from about less than 1% to about 50%. Mole fraction refers to that fraction of sulfonic acid groups that may be transformed to sulfone or sulfonate esters by the grafting reaction. By way of example, the mole fraction of R₁ and/or R₂ groups incorporated into the backbone of the polymer chain can be from about 5% to about 10% (e.g., about 5%).

Other bulky groups and/or cross-linkable groups can also improve the dimensional stability of the poly(phenylene sulfonic acids). Other bulky groups can include tert-butylalkyl groups, tert-butyl phenyl groups, di(tert-butyl)phenyl groups, tert-butyl groups, tert-butyl benzyl groups, tert-butylaryl groups, tert-butylalkylaryl groups, di(tert-butylalkyl)aryl groups, tert-butyl hydroxyl, alkoxy, or aryloxy phenyl groups, di(tert-butyl)hydroxyl, alkoxy, or aryloxy phenyl groups, bulky aryl groups, bulky alkylaryl groups, tert-amyl groups, adamantyl groups, adamantylphenyl groups, substituted and unsubstituted phenols, thiophenols, trimethyl silyls, silicones, and their ethers as well as linear and branched fluoroalkyl groups, fluoroalkyl sulfones, and block hydrocarbon/fluorocarbon groups, such as groups with the formula F(CF₂)ₙ(CH₂)ₘ⁻, where m can be 0, 1, or 2, and n can be about 1 to about 10 (e.g., 6, 8, or 10). Other cross-linkable groups can include 1,3,5-triphenyl benzene, trypticene, tetraphenyl methane, tetracylene, perylene, naphthalene, naphthacene, chrysene, pentacene, picene, anthracene, hexacene, rubicene, phenanthrene, other polycylic aromatic hydrocarbons, molecules that contain aryl or other cross-linkable groups, and ethers thereof.

In accordance with yet another aspect of the present invention, the liquid crystal polymers can comprise a hydrolytically stable poly(phenylenedisulfonic acid) copolymer. As shown below, the poly(phenylenedisulfonic acid) copolymer can include random, graded, or block repeating units of phenylene disulfonic acid and a second repeating unit, R₁, that includes a non-polar aryl group:

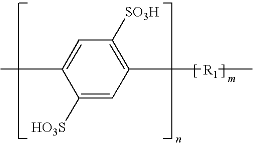

where n can be an integer greater than or equal to 1 for a random, graded and/or block copolymer, and m is 1 for a random copolymer, an integer greater than 1 for a block copolymer, and an average of one or greater for a graded copolymer.

The sulfonic groups in the phenylene disulfonic acid repeating unit provide for proton conductivity and, when the polymer is formed into a membrane, promote the passage of hydronium ions across the membrane. The non-polar aryl repeating unit can have a geometry that results in the separation of adjacent copolymer molecules from one another and keeps the copolymer insoluble. Such displacement creates regions of access, nanopores, or channels along respective polymer chains. The regions of access along the polymer chains expose sulfonic groups along the backbone of the respective polymers.

The mole fraction of comonomers, i.e., R₁ groups, incorporated into the copolymer chain, can be that percentage, which does not adversely affect the mechanical properties, hydrolytic stability, thermal stability, etc. of the resulting copolymer. In one example, the mole fraction of comonomer in the copolymer can be in the range of about less than 1% to about 33%. Another example of the mole fraction of R₁ groups incorporated into the backbone of the polymer chain can be from about 5% to about 25%. Typically, the mole fraction of comonomer repeating units incorporated into the copolymer chain is such that the fraction of phenylene disulfonic acid repeating units (n) is substantially equal to or greater than the fraction of comonomer units (m). For example, the n:m ratio can be least about 1:1, and more particularly at least about 4:1.

The comonomer that is used to form the second repeating unit can be formed from a dihalo-aryl sulfonate or dihalo-aryl disulfonate using an Ullman coupling reaction. The comonomer can comprise, for example, a poly(phenylene disulfonate) monomer or a poly(phenylene sulfonate monomer), such as shown below:

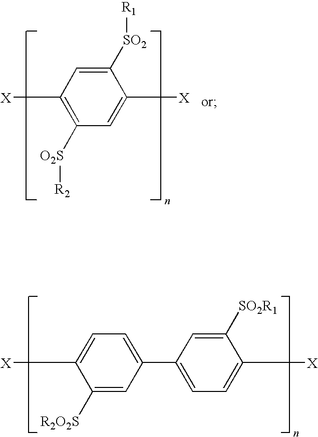

wherein X is a halogen, such as Br, Cl, and/or I, and where at least one R₁ or R₂ that is attached to a sulfonyl group comprises a bulky group (e.g., di-(tert-butyl)hydroxyphenyl) and/or a cross-linkable group (e.g., biphenyl), the other group (i.e., R₁ or R₂) being a hydroxyl group or a bulky group (e.g., di-(tert-butyl)hydroxyphenyl) and/or a cross-linkable group and where n is at least 1.

Optionally, the comonomer that is used to form the second repeating unit can be synthesized from an aryl diboronic acid or ester. The aryl diboronic acid or ester can be readily transformed into a non-polar comonomer, such as a non-polar dihalo-comonomer, by reacting an aryl diboronic acid or ester with a dihalo-aryl using a Suzuki coupling reaction. The non-polar comonomer so formed can then be readily polymerized with the dihalo-benzenedisulfonic acid via an Ullmann coupling reaction or another coupling reaction.

By way of example, an aryl diboronic acid can be formed into a non-polar comonomer as shown below.

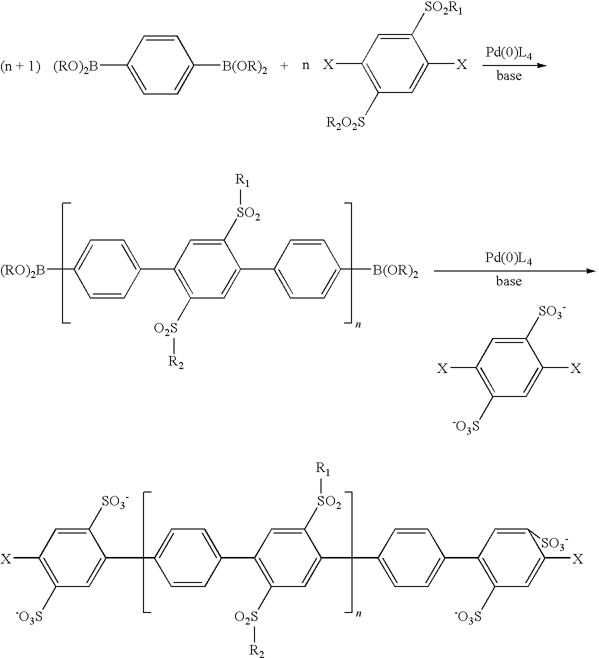

wherein X is a halogen, such as Br, Cl, and/or I, and where at least one R₁ or R₂ that is attached to a sulfonyl group comprises a bulky group (e.g., di-(tert-butyl)hydroxyphenyl) and/or a cross-linkable group, the other group (i.e., R₁ or R₂) being a hydroxyl group or a bulky group (e.g., di-(tert-butyl)hydroxyphenyl) and/or a cross-linkable group where n is at least 1. It will be appreciated that other aryl diboronic acids or esters can be used to form the comonomer. The other aryl diboronic acid or esters can be linear as shown above, slight non-linear, or non-colinear. Examples of non-colinear aryl diboronic acids or esters are shown below:

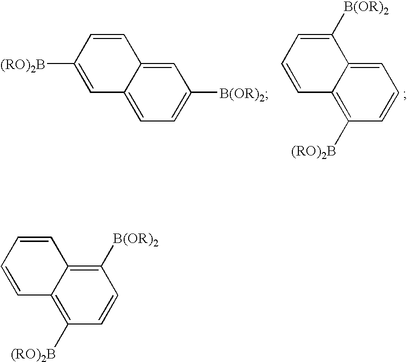

The comonomers shown above can be copolymerized randomly or in blocks to give tri- or multiblock polymers with relatively long hydrophobic sequences (e.g., 5-100-5). The large cross-sectional area of the comonomers combined with the rigid rod structure means that molecules in the ionic part of the chain must remain separated even if the polymer is at a low humidity.

It will be appreciated that the foregoing comonomers can include other bulky groups and/or cross-linkable groups. Such other bulky groups can include tert-butylalkyl groups, tert-butyl phenyl groups, di(tert-butyl)phenyl groups, tert-butyl groups, tert-butyl benzyl groups, tert-butylaryl groups, tert-butylalkylaryl groups, di(tert-butylalkyl)aryl groups, tert-butyl hydroxyl, alkoxy, or aryloxy phenyl groups, di(tert-butyl)hydroxyl, alkoxy, or aryloxy phenyl groups, bulky aryl groups, bulky alkylaryl groups, tert-amyl groups, adamantyl groups, adamantylphenyl groups, substituted and unsubstituted phenols, thiophenols, trimethyl silyls, silicones, and their ethers as well as linear and branched fluoroalkyl groups, fluoroalkyl sulfones, and block hydrocarbon/fluorocarbon groups, such as groups with the formula F(CF₂)ₙ(CH₂)ₘ⁻, where m can be 0, 1, or 2, and n can be about 1 to about 10 (e.g., 6, 8, or 10). Other cross-linkable groups can include 1,3,5-triphenyl benzene, trypticene, tetraphenyl methane, tetracylene, perylene, naphthalene, naphthacene, chrysene, pentacene, picene, anthracene, hexacene, rubicene, phenanthrene, other polycylic aromatic hydrocarbons, molecules that contain aryl or other cross-linkable groups, and ethers thereof.

Other comonomers that can be used to form the copolymer can include slightly non-linear aryl groups, such as fluorene and 2,7-9,9′-spirobifluorene (DHSF), which are shown below:

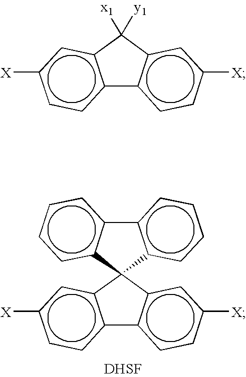

where x₁ and y₁, can be H, an aryl, a substituted aryl, or other alkyl groups and where X is I, Cl, Br, and/or a diboronic acid or ester (e.g., B(OR)₂). DHSF (and fluorene) can also include sulfonic groups that provide for proton conductivity and, when a copolymer comprising DHSF is formed into a membrane, promote the passage of hydronium ions across the membrane. The sulfonic groups can be attached, for example, at the 1 and 8 position of DHSF to form respectively 2,7-dihalo-9,9′-spirofluoroene-1,8-disulfonic acid (DHSFSA) as shown below.

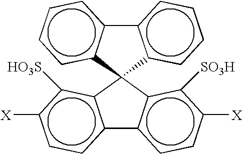

It will appreciated that the sulfonic groups can be attached at other positions on the DHSF structure as shown below.

A 4-halobenzene-3-sulfonic acid moiety can also be added to each end of the DHSF to make a monomer shown below.

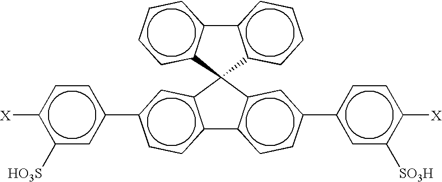

Other examples of comonomers having a similar structure to DHSF can also be copolymerized with a dihalo-benzene disulfonic acid to form random and block poly(phenylene disulfonic acid) copolymers. These similar structures include:

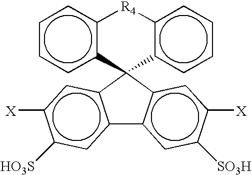

where X is a halogen (i.e., halo group), such as Br, Cl, and/or I, and R₄ is O, S, or SO₂.

An example of yet another comonomer that can be copolymerized with a dihalo benzene disulfonic acid to form a random and block poly(phenylene disulfonic acid) copolymer has the following.

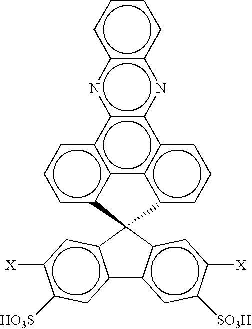

where X is a halogen (i.e., halo group), such as Br, Cl, and/or I.

Other examples of comonomers that include bulky, angled, and/or cross-linkable groups and that can be used in forming a liquid crystal poly(phenylene disulfonic acid) copolymer in accordance with the present invention include the following:

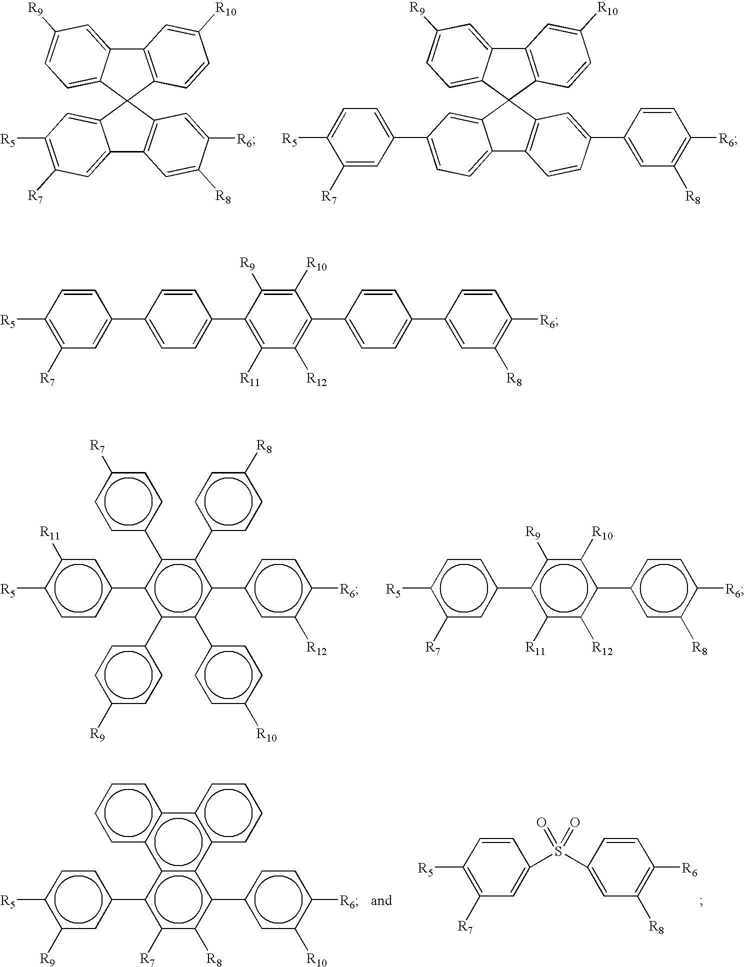

or mono-sulfonic acid or poly-sulfonic acid variations thereof; wherein R₅ and R₆ are Br, Cl, or I, and R₇, R₈, R₉, R₁₀, R₁₁, and R₁₂ each independently represent, for example, H, SO₃H, alkyl (methyl, ethyl, propyl, isopropyl, butyl, etc.),

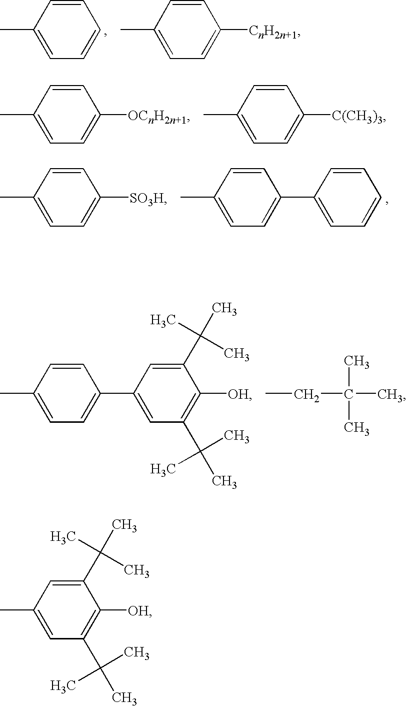

alkoxy (e.g., methoxy and ethoxy), alkyloxy, aroxy (e.g., phenoxy), alkylaryloxy, substituted or hetero-atom variations thereof, ethers thereof, or mono-sulfonic acid or poly-sulfonic acid variations thereof.

Other examples of comonomers that can be used in forming a liquid crystal poly(phenylene disulfonic acid) copolymer in accordance with the present invention include benzo-bisoxazole, bisthiazole and bisimidazole units linked to phenylene sulfonic acids or bearing a sulfonic acid on the central ring.

Additional examples of comonomers that include that can be used in forming liquid crystal poly(phenylene disulfonic acid) copolymer in accordance with the present invention are described in U.S. Pat. No. 6,585,561, which is herein incorporated by reference. These monomers can include dihalo compounds prepared from a diamine selected from the group consisting of 1,4-p-phenylene diamine (PDA); 4,4′-(9 fluorenyl) dianiline (FDA), 4,4′-oxydianiline (ODA), 1,4-bis(4-aminophenyl)-2,3,5-triphenyl benzene ((3P)TDA), 1,4-bis(4-aminophenyl)-2,3,5,6-tetraphenyl benzene ((4P)TDA); 2,2′-dibenzoyl-benzidine (DBB), 1,4 bis-(4-aminophenyl)-2,3-di(biphenyl)-5,6-diphenyl benzene (DBPDPDA), 1,4-bis-(4-aminophenyl)-2,3,-di(2-naphthyl)-5,6-diphenyl benzene (DNDPDA), 1,1′-bis-(4-aminophenylene)-4,4′-(1,4-phenylene)bis-(2,6-diphenyl pyridinium tetrafluoroborate), 1,1′-bis-(4-aminophenylene)-4,4′-(1,4-phenylene)bis-(2,6-bis(4-methyl phenylene)pyridinium tetrafluoroborate), 1,1′-bis-(4-aminophenylene)-4,4′-(1,4-phenylene)bis-(2,6-bis(4-ethoxy phenylene)pyridinium tetrafluoroborate), 2′,6′,3″,5′″tetra (R-phenyl) 4,1″″-diaza-pentaphenylene diamine (NHA [R═H]; NMA [R═CH₃], NEA [R=ethoxy]), 1,5-diaminonaphthalene (1,5-DAN); 2,6-diaminoanthraquinone (2,6-DAA); 1,5-diaminoanthraquinone (1,5-DAA), Dm-APNTCDI, tris(4-aminophenyl)methane (TAM); 2,2′-bis(trifluoro methyl)benzidene (TFMB), and 3,8-diamino-6-phenylphenanthridine (DAPP).

PDA, FDA, ODA, 1,5-DAN, TAM, and TFMB are commercially available compounds. (3P)TDA, (4P)TDA, DBPDPDA and DNDPDA are synthesized according to known procedures as described by Sakaguchi et al. in Polym. J., 1992, 24 (10), 1147, hereby incorporated by reference. NHA, NMA, and NEA are synthesized according to known procedures described by Spiliopoulis et al. in Macromolecules, 1998, 31,515, also hereby incorporated by reference.

DBB is synthesized via Ullmann coupling of 2-halo,-5-nitrobenzophenone and reduction of the nitro groups to amines.

Comonomers used in accordance with the present invention can be classified according to their structure and the location of the halo groups. Dihalo compounds prepared from FDA and ODA are angled comonomers, in that the dihalo groups are not in a linear arrangement.

Dihalo compounds prepared from DBB, (3P)TDA, (4P)TDA, DBPDPDA, DNDPDA, 1,1′-bis-(4-aminophenylene)-4,4′-(1,4-phenylene)bis-(2,6-diphenyl pyridinium tetrafluoroborate), 1,1′-bis-(4-aminophenylene)-4,4′-(1,4-phenylene)bis-(2,6-bis(4-methyl phenylene)pyridinium tetrafluoroborate), 1,1′-bis-(4-aminophenylene)-4,4′-(1,4-phenylene)bis-(2,6-bis(4-ethoxy phenylene)pyridinium tetrafluoroborate), NHA, NMA; NEA and 3,8-diamino-6 phenylphenanthridine (DAPP) are monomers having a linear chain, halo terminated at both ends, with bulky pendent groups attached to the chain.

Dihalo compounds prepared from 1,5 DAN, 2,6 DAA, 1,5 DAA, and Dm-APNTCDI are displacing comonomers that displace the polymer backbone laterally without changing its direction, such that sections or portions of the polymer chain are not necessarily coaxial, but are still co-linear, or substantially so. Displacing comonomers also serve to separate the polymer chains and create nanopores.

The comonomer can also be a dihalo compound prepared from a diamine disclosed in U.S. Pat. No. 6,586,561, including, for example:

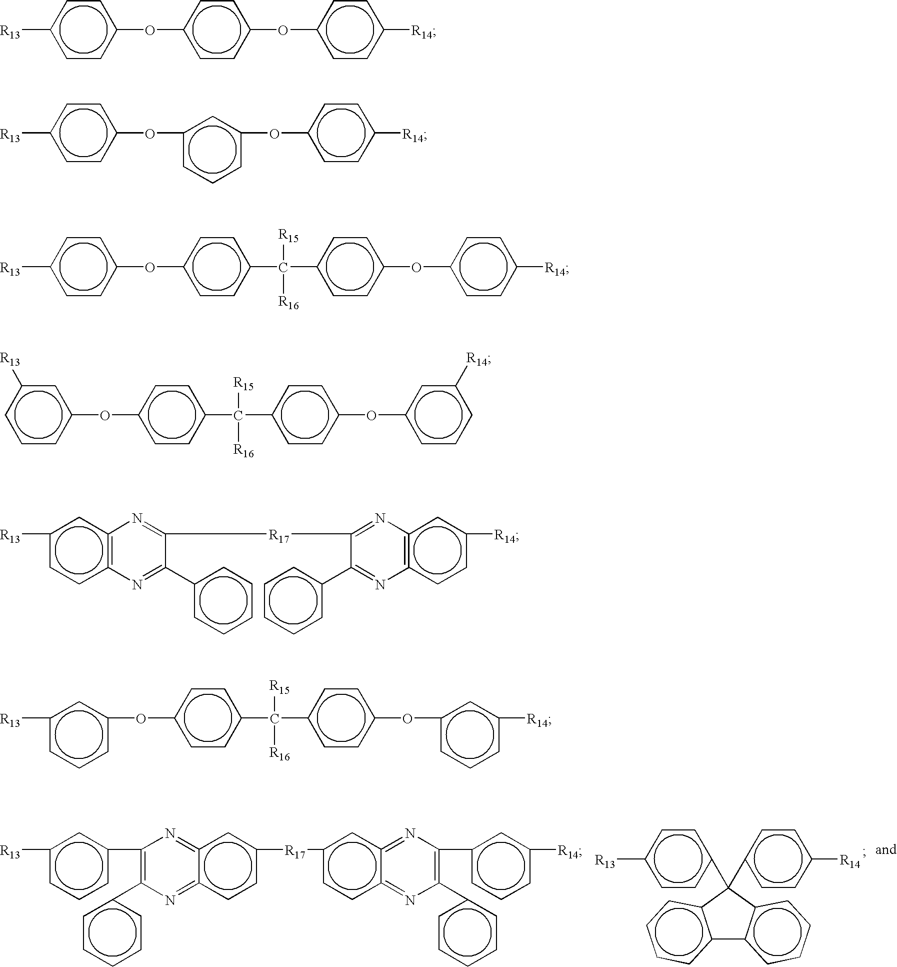

mono-sulfonic acid or poly-sulfonic acid variations thereof, and wherein R₁₃ and R₁₄ each independently represent Br, Cl, or I; where R₁₅ and R₁₆ each independently represent H, SO₃H, alkyl (methyl, ethyl, propyl, isopropyl, butyl, etc.),

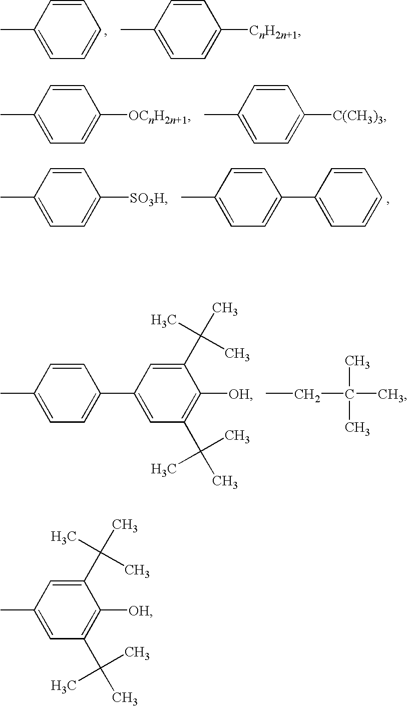

alkoxy (e.g., methoxy and ethoxy), alkyloxy, aroxy (e.g., phenoxy), alkylaryloxy, substituted or hetero-atom variations thereof, ethers thereof, or mono-sulfonic acid or poly-sulfonic acid variations thereof; and where
R₁₇ can be, for example,

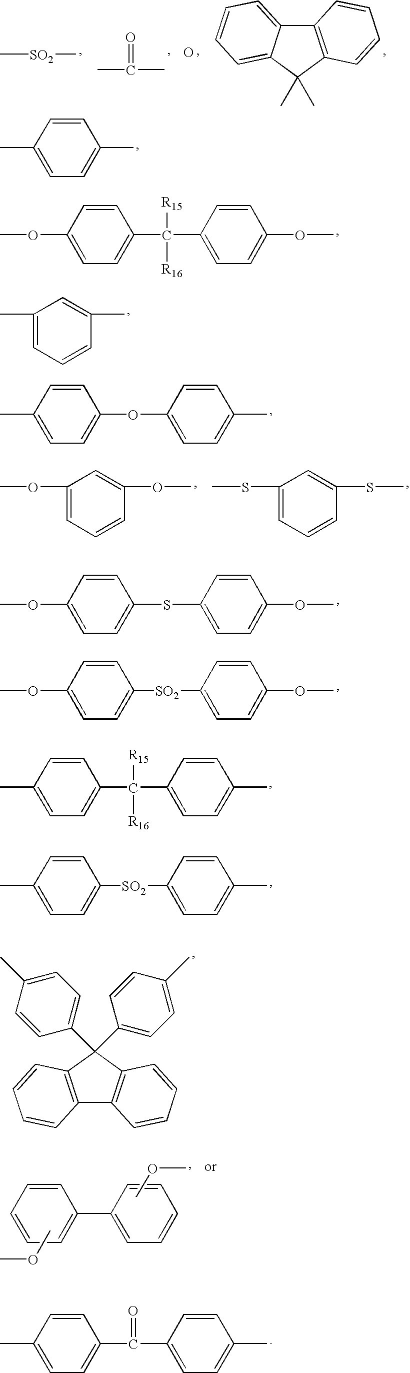

As will be appreciated, a wide array of comonomers can be used in forming the copolymers of the present invention. Potentially any comonomer can be used in forming the poly(phenylenedisulfonic acid) copolymer as long as the hydrolytic stability of the copolymer is maintained and the comonomer does not adversely affect the properties of the resulting polymer (e.g., conductivity).

The poly(phenylenedisulfonic acid) copolymers, like the homopolymers in accordance with the present invention, can be formed in an Ullmann coupling reaction from 1,4-dihalo-benzenedisulfonic acids and at least one comonomer. It will be appreciated that the 1,4-dihalo-benzenedisulfonic acids can be copolymerized with the comonomer using other procedures as long as these other procedures are not inhibited by the sulfonic groups. Examples of these other approaches can include using different coupling reagents or catalysts, such as palladium (Pd), nickel (Ni), or nickel/zinc (Ni(0)/Zn), which are disclosed in Lemaire et al., Aryl-Aryl Bond Formation One Century After the Discovery of the Ullmann Reaction, Chem. Rev. 2002, 102, 1359-1469, herein incorporated by reference.

The microstructure of the copolymer can be controlled so that a random copolymer to graded block copolymer is formed. A random copolymer when formed into PEM can have enhanced conductivity with high dimensional stability. Phase segregation should occur in a PEM formed from an ABA or (-A-B-)ₓ block copolymer.

Block copolymers comprising the poly(phenylenedisulfonic acid) copolymers can be formed by several routes. For example, the base monomer (e.g., 1,4-dihalo-benzendisulfonic acid) can be initially polymerized to form a polymer (e.g., poly(phenylenedisulfonic acid)) with a low molecular weight. A comonomer in accordance with the present invention can then be added to the low molecular weight polymer (e.g., poly(phenylenedisulfonic acid)) and the reaction can be continued.

To facilitate solvation of the foregoing non-polar comonomers in polar solvents during copolymerization, the non-polar comonomers can also include a carboxylic acid group (COOH group). By putting a COOH group on the non-polar comonomers, the COOH group will be ionized under basic conditions of copolymerization but will be in the acid form when in the polyelectrolyte membrane and should not interact strongly with water.

If the comonomer in accordance with the present invention is less reactive than the base monomer, both the base monomer and the comonomer can be initially combined and reacted together. The first polymer formed will comprise primarily the base monomer. As the polymer grows, the ends will become richer in the comonomer. This will give a graded block copolymer. Depending on the comonomer reactivity, a tri-block or multi-block polymer can be formed.

A chain stopper (i.e., chain terminator) can be added to the reaction of the base monomer and the comonomer to form a tri-block polymer. Where the base monomer is allowed to initially polymerize, the chain stopper can be added to the partially polymerized base monomer at the same time as the comonomer. Where both the base monomer and the comonomer are initially combined and reacted, the chain stopper can be added toward the end of the reaction, when a copolymer is already formed.

The poly(phenylenedisulfonic acid) copolymers can be chemically modified to incorporate bulky side groups and/or cross-linkable groups. The bulky side groups and/or cross-linkable groups can improve the dimensional stability of the poly(phenylenedisulfonic acid)s and render the poly(phenylene disulfonic acid)s substantially water insoluble. The bulky side groups and/or cross-linkable groups can also have a geometry that results in the separation of adjacent polymer molecules from one another. The bulky and/or cross-linkable side groups can be incorporated onto the backbone of the poly(phenylene sulfonic acid) copolymer via a sulfone formation reaction.

The rigid, rod liquid crystal polymers so formed in accordance with the present invention can organize as nematic liquid crystals. Because of the liquid crystal nematic organization, liquid crystal polymer molecules in cast films are perpendicular to the surface of the film. This restricts swelling of the film in directions parallel to the film. This also provides opportunities to modify many important properties of films, such as free volume, with consequent water retention and conductivity, by small changes in the liquid crystal polymer structure.

The liquid crystal polymers may also form aggregates or micelles that have a substantially planar structure with sulfonic acid groups covering the planar structure surface. Molecules of water can then be trapped by the sulfonic groups between adjacent micelles. Additionally, because of their liquid crystal structure, films formed from the polymers of the present invention are substantially MeOH impermeable.

For polymer electrolyte membrane (PEM) applications, it may be desirable to incorporate the liquid crystal polymer in accordance with the present invention into an electrochemically inert matrix to improve the mechanical stability of the liquid crystal polymer. The electrochemically inert matrix can provide mechanical support for a film of the liquid crystal polymer. Mechanical support can reinforce the film and allow for higher elongations of the film. The electrochemically inert matrix can comprise, for example, poly(vinylidene fluoride) (PVDF), polytetrafluorethylene (PTFE), or polychlorotrifluoroethylene (CTFE). Alternatively, other matrix materials can be substituted for, or blended or copolymerized with PVDF, PTFE, or CTFE.

By way of example, a PEM comprising a matrix incorporated with the liquid crystal polymer can be formed by initially selecting a membrane composed of a highly expanded inert polymer (e.g., PVDF). Membranes are commercially available from Waters Corporation. The membrane can then be impregnated with a solution of the liquid crystal polymer. Alternatively, an inert polymer, such as PVDF, and the liquid crystal polymer can be mixed in a solvent, such as DMF or DMAc, which is capable of dissolving both the liquid crystal polymer and the inert polymer and then cast to form the membrane.

The following examples are included to demonstrate various aspects of the invention. Those skilled in the art should, in light of the present disclosure, appreciate that many changes can be made in the specific aspects which are disclosed and still obtain a like or similar result without departing from the spirit and scope of the invention.

### EXAMPLE

The following example describes the synthesis and properties of new monomer, 1,4-dibromo-2,4-benzenedisulfonic acid (DBBDSA) and sulfonated poly(p-phenylene)[poly(p-phenylene-2,5-disulfonic acid), PPDSA] formed from the monomer.

### Experimental Procedures

### Materials

All reagents except 15% oleum (the concentration of SO₃ gas=13˜17%, purchased from Alfa Aesar) and the cation exchange resin, Rexyn 101 (2.05˜2.2 meq./g exchange capacity, purchased from Fisher) were purchased from Aldrich Chemical Co. N-methylpyrrolidinone (99%) and dimethylformamide (DMF) were stirred overnight with calcium hydride, vacuum distilled and degassed with Ar gas prior to use. The remaining solvents and reagents were used without further purification. Copper bronze powder (for organic synthesis) was activated according to a previously reported procedure and was used immediately after preparation.

### Characterization Techniques for DBBDSA Monomer

¹H- and ¹³C-NMR spectra of the monomers having different salts were obtained using a Varian Gemini 300 MHz or a Varian Inova 600 MHz spectrometer using D2O and DMSO-d6. FT-IR spectra of KBr pellets were recorded on a BOMEM Arid Zone FTIR spectrometer. The monomer melting point was measured using DSC (Differential Scanning Calorimeter) at a 10° C./min rate under N₂ gas.

### Characterization Techniques for PPDSA

### NMR Spectroscopy

¹H- and ¹³C-NMR spectra of the polymers, diprotonated form and disodium salt in D₂O were obtained using a Varian Gemini 300 MHz or a Varian Inova 600 MHz spectrometer. The 1H-NMR spectra were deconvoluted using the ACD Labs: curve processing module (version 9.05).

### Rheology Measurements

Rheological studies were performed on a Physica MCR501 Rheometer (Anton Paar Company). Measurements were made using cone and plate geometry (CP25-1-SN4514) with a diameter of 25 mm and a gap of 53 um between the cone and plate. Viscosities of samples were measured at shear rates ranging from 1.0×10⁻³ to 100 s⁻¹. The test temperature was 20±2° C. Samples were prepared by dissolving diprotonated PPDSA in D.I. water. Different sample concentrations were made by dilution in stages from the highest concentration of aqueous polymer solution (38.5 g/dL) to 0.03 g/dL.

### GPC (Gel Permeation Chromatography)

Solvent (DMF or 0.01M LiBr in DMF) was pumped from a solvent reservoir by a Waters 510 pump at 0.7 mL/min through a column system consisting of a guard column and two main columns (Waters HR-5E DMF and HR-4E DMF). The sample injection was made through a GPC valve with an injection loop (200 uL) fitted between the pump and the column. The eluted sample passed first through a UV detector (Waters 996 Photodiode Array Detector), and then to a refractive index detector (Waters 2414 Refractive Index Detector) before it was collected. The column chamber temperature was controlled at 35 or 150° C. depending on test conditions, and the refractive index cell temperature was set at 50° C. A calibration curve was obtained using polystyrene standards (PSS ReadyCal Polystyrene standard kit (SDK-600), Polymer Standard Service-USA Company) to calculated a relative molecular weight of polymer. GPC samples with the desired concentrations (1.0 g/dL or 0.125 g/dL) were prepared by dissolving the polymer in a DMF/D.I. water mixture (v/v, 67/33). Before injection, the solution was filtered through a PTFE membrane filter (0.45 um).

### Viscosity Measurements

Reduced viscosities of dilute solutions of PPDSA (dilithium, disodium, diTBP (tetrabutyl-phosphonium) and the diprotonated forms) in D.I. water, DMF, and DMF/NMP (v/v, 33/67) with various salt concentrations (0.3M LiCl, or 0.1, 0.5, 1.0M LiBr) were measured using Ubbelohde type viscometers. Dilute polymer solutions at concentrations between 0.7 g/dL and 1.0 g/dL were prepared by dissolution of PPDSA films after drying at 90° C. for 1 day. Measurements of the solution flow time were extrapolated, as reduced viscosity, to zero concentration to hopefully obtain the intrinsic viscosity. The PPDSA solution was diluted by adding the same solvent or solution which was used to make the polymer solution. By selecting the capillary width, the time (t) needed for the solvent to flow through the capillary tube was adjusted to be above 4 mins (except viscometers IC C282 and 1 J659). Prior to measurement, all the solutions were filtered through a 0.45 μm pore diameter PTFE membrane filter. Flow times were measured at least three times (accuracy of ±0.1 s) for each concentration.

### Water Uptake

### Water Content Evaluation.

The water content of the polymer films was evaluated as a function of relative humidity using two techniques: weight increase and sulfonic acid titration. The difference in weight of the polymer films between the dry and humidified states was quantified using several strips of film of about 200 μm thickness, 3 mm long and 2 mm wide. The weighing bottles (with a ground glass joint and cap) were placed in an oven at 120° C. for 24 hours. After drying, the bottles were taken out of the oven and quickly put in desiccators containing dried molecular sieves (4 Å) for cooling. The weights of the weighing bottle and cap were measured before putting dried film into the bottle. After the film was vacuum dried at 90° C. for 24 hours, the dried film was weighed in the pre-weighed capped weighing bottle. Weighing bottles containing polymer films were opened and placed in different % RH chambers containing lithium chloride solutions providing controlled relative humidities ranging from 11% to 75% RH. The LiCl solution preparation followed the protocol reported previously.

### Lambda (λ) Measurement

Sodium chloride and sodium hydroxide aqueous solution used in titration were made with D.I. water boiled to remove CO₂. Sodium hydroxide solution was standardized as follows; 2.0 mL of potassium hydrogen phthalate aqueous solution (0.103M) and phenolphthalein ethanol solution (2 to 3 drops) as an endpoint indicator were put into a beaker. Sodium hydroxide aqueous solution (about 0.01M) was placed in a 50 mL burette and the potassium hydrogen phthalate solution was titrated drop by drop with stirring until a permanent light pink was shown. The molar concentration of the sodium hydroxide solution was calculated from the volume of sodium hydroxide solution used. This standardization was carried out before and after the sulfonic acid titration. The sulfonic acid titration was performed using films that had been equilibrated at controlled relative humidities in the same manner as described for the water uptake test. The weights of dried (W1′) and humidified (W2′) films were recorded using the same procedures as in the water uptake test, and 5 ml of 2M aqueous sodium chloride was added to each bottle. The resulting solution was titrated with the standardized sodium hydroxide solution using phenolphthalein as the end-point indicator. The concentration of sulfonic acid was calculated from the titration volume. The weight of absorbed water was the difference between the dried and humidified film weights. Using those data, lambda (λ), the number of water molecules per acid group in the membrane, at different humidities was calculated using Equation 2.3.

$$Lambda ( λ ) = \frac{( {W}_{2}^{′} - {W}_{1}^{′} ) / 18}{[ {SO}_{3} H ]} \qquad ( Equation 2.3 )$$

where (W₂′−W₁′) is the weight difference between the dried and humidified films, the weight of absorbed water, and (W₂′−W₁′)/18 is the moles of water absorbed by the polymer film. [SO3H] is the moles of sulfonic acid determined from the titration with the standardized sodium hydroxide solution.

### Differential Scanning Calorimetry (DSC)

DSC measurements were performed using a Mettler Toledo STARe system, DSC (822^{e}/700) with a HAAKE EK90/MT cooling accessory and a TS0800GC1 N₂ flow control controller. Standard aluminum crucibles, 40 μl, with pin and lid (part #00027331) were used. To hydrate the PPDSA films, about 5-10 mg of a previously dried film was placed on a glass slide in a controlled relative humidity chamber (15 to 75% RH) at room temperature for about 24 hours. The films was then transferred immediately to an aluminum pan and hermetically sealed. The sealed DSC crucibles used for high temperature scanning had a hole in the lid made by inserting a 23 gauge needle through the lid before running the experiment, while those used at low temperature did not have a hole. Data were collected at 10° C./min for scans at low temperature (−50 to 60° C.) and scans at high temperature (25 to 300° C.). As controls, a well-dried PPDSA sample (0% RH) and bulk water (D.I. water, filtered through a 0.45 um PTFE membrane) were tested in the same way.

### Thermogravimetric Analysis (TGA).

TGA experiments were performed using TA-instruments TGA analyzer 2950. Heating rates of 110° C./min were used. All experiments were performed under N₂ atmosphere (60 mL/min). A dried sample was prepared by vacuum drying at 90° C. for 1 day. Then, the sample was put into the TGA pan and heated from 25 to 800° C. (platinum pan, ramp 10° C./min).

Dimensional Change with Water Uptake

The dimensional change of a polymer film was measured as a function of relative humidity. Initial dimensions (length, width and thickness) of the polymer films were measured using calipers (length and width) and a micrometer (thickness) after vacuum drying for 1 day at 90° C. Polymer films were stored in different relative humidity controlled chambers (as described in the water uptake test) for 24 hours and the dimensional changes were measured by calipers (length and width) and optical microscope (thickness). The X-axis is perpendicular and the Y-axis is parallel to the casting direction. The Z-axis is the thickness direction (Scheme 2.2).

### Proton Conductivity Measurements

Proton conductivity was measured using the AC impedance method in a 4-probe configuration. Two outer probes supply current to the cell, while the two inner electrodes measure the potential drop. PPDSA films were cut into approximately 3 cm by 0.3 to 0.4 cm strips. In order to study the possible orientation of the PPDSA molecules due to casting shear, strips were cut parallel and perpendicular to the casting direction. All the films were vacuum dried at 90° C. for 1 day, and the thickness and width of the polymer films were measured before assembling the conductivity cells.

### Wide Angle X-Ray Diffraction (WAXD)

For the WAXD measurements, linear θ/2θ X-ray intensity scans were recorded using a Rigaku diffractometer with CuKα radiation (1.542 Å) with a long fine focus mode.

For measurements of the orientation of polymer chains, specimens were prepared by cutting films parallel and perpendicular to the casting direction. The PPDSA films, after vacuum drying at 90° C. for 1 day, were equilibrated on PVC film-covered glass slides at 11, 15, 35, 50 and 75% RH in a closed chamber for more than 8 hours.

### 2D X-Ray Diffraction

2D X-ray diffraction spectra were recorded at room temperature on Kodak Direct Exposure X-ray film (DEF5) using a Searle toroidal X-ray camera and Nifiltered CuKα radiation. Vacuum was not applied because it could dehydrate the film. The PPDSA films at different relative humidities were prepared using the same procedure as for the WAXD experiments. They were mounted on the X-ray diffraction frame using double-sided tape. CaF2 was used as an internal standard. The exposure time was about 24 hours. The lack of vacuum meant that air scattering was recorded. After developing the image, d spacing values of the polymer sample peaks were calculated from the peak diameter using the 20 value (28.31°) of CaF2 as a reference.

### Optical Polarizing Microscope (OPM)

The PPDSA films for OPM were prepared using a process similar to that for the WAXD sample preparation. The film was prepared by vacuum drying at 90° C. for 1 day. The dried film was put on a dried glass slide and sealed with PVC film to protect from air humidity. The humidified samples were prepared as follows; 1) The dried films were put on glass slide and equilibrated in different relative humidity chambers for 1 day, 2) The humidified films were sealed with PVC film and the images were recorded. Solution samples were prepared as follows; 1) One drop of polymer solution was placed on a glass slide, 2) The drop was covered with a cover glass (˜100 um) and an image was recorded. OPM images were recorded using an Olympus polarized light microscope equipped with a CCD camera.

### Dynamic Mechanical Analysis (DMA)

All mechanical tests were performed using films approximately 3 cm. long and 2˜5 mm wide, with thicknesses of about 200 μm. Stress-strain measurements were made using a TA Instruments Q800 dynamic mechanical analyzer under a N₂ atmosphere. For the stress-strain test, a controlled force mode was applied as a linear ramp from 1.0 N/m to 18N. Sample preparation at different humidities was the same as for the other tests.

### Synthetic Procedures for 1,4-dibromo-2,5-benzenedisulfonic acid (DBBDSA)

### Synthesis of 1,4-dibromo-2,5-benzenedisulfonic acid, disodium salt (DBBDSA-Na)

In a 500 mL one neck flask containing an egg-shaped spin bar were charged 1,4-dibromobenzene (98%, 32.02 g, 133 mmole) and 15% oleum (99 mL, the concentration of SO3 gas was 13˜17%). A condenser was fitted to the flask and the reaction mixture was covered with Ar gas. The reaction mixture was stirred and heated in a bath at 220˜230° C. for 24 hours. The reaction solution was cooled to room temperature and slowly poured into about IL crushed ice. The brownish acidic aqueous solution was warmed to room temperature and undisolved solid was removed by filteration (less than 0.1 g). Sodium carbonate (about 60 g) was added portion wise to the filterate to convert it to the sodium salt form. The solution was condensed to about 400 mL; brownish solids salted out after 1 day at room temperature and were filtered using a sintered glass funnel. The salted-out solid, a crude mixture of 1,4-dibromo-2,5-benzenedisulfonic acid, disodium salt (para substituted form) and 1,4-dibromo-2,6-benzenedisulfonic acid, disodium salt (meta substituted form) was dissolved in D.I. water, and neutralized with sodium carbonate to pH 7 by checking with pH paper. This avoided acid decomposition of the organic solvent that was used in next step. The neutral solution was evaporated by rotaevaporator and the obtained solid was dried under vacuum at 90° C. for 2 days. The solid was stirred in DMF at room temperature for 1 day to separate sodium sulfate (by-product in neutralization), and filtered. The DMF was evaporated and the solid was vacuum dried at 90° C. for 2 days. To get pure 1,4-dibromo-2,5-benzenedisulfonic acid, disodium salt, the solid was extracted with ethanol using Soxhlet extraction. The pure 1,4-dibromo-2,5-dibenzene-sulfonic acid, disodium salt is much less soluble than 1,4-dibromo-2,6-benzenedisulfonic acid, disodium salt, and it remained in the thimble. The extraction process was monitored using 1H- and 13C-NMR to decide the extraction time. After extraction for 1˜2 days, solids in the thimble were vacuum dried at 90° C. for 1 day and examined using 1H- and 13C-NMR. The extraction process was repeated until the only desired product was remained in the thimble. Finally, the desired, 1,4-dibromo-2,5-benzene-disulfonic acid, disodium salt (DBBDSA-Na) was obtained after vacuum drying at 90° C. for 1 day. Yield was 38% (22.0 g). ¹H-NMR (D₂O): δ=8.14 ppm (s, 2H); ¹³C-NMR (D₂O): δ=118.3 (C—Br), 135.2 (C—H), 144.9 ppm (C—SO₃H); FT-IR (KBr pellet) 3088 (aromatic C—H stretching), 1434 (C—C ring stretching), 1313 (in-plane ring bending), 1223 (asymmetric stretching of SO₂), 1080 (symmetric stretching of SO₂), 908 (C—H out-of-plane deformation for p-substituted benzene), 675 (out-of-plane ring bending), 656 (C—Br stretching) cm⁻¹. The melting temperature of 1,4-dibromo-2,5-dibenzene-sulfonic acid, disodium salt (DBBDSA-Na) was 243° C., measured by DSC.

### Synthesis of 1,4-dibromo-2,5-benzenedisulfonic acid, dibenzyltrimethylammonium (BTMA) salt (DBBDSA-BTMA)

DBBDSA-Na (6.47 g, 14.7 mmole) was dissolved in 60 mL D.I. water and ion-exchanged to BTMA salt form by passing through a BTMA loaded cationic exchange resin. The collected aqueous solution was evaporated and dried under vacuum at 70° C. for 1 day. The final DBBDSA-BTMA was recrystallized from D.I. water at room temperature. The white solid was filtered using a Büchner funnel and dried under vacuum at 70° C. for 1 day. Yield was 90%. ¹H-NMR (D₂O): δ=8.14 ppm (s, 2H), δ=7.40˜7.47 ppm (m, 10H), δ=4.35 ppm (s, 4H), δ=2.97 ppm (s, 18H); FT-IR (KBr pellet): 3033 (C—H stretching in benzene), 2981 (aliphatic C—H stretching), 1304 (in plane ring bending), 1230 (asymmetric stretching of SO₂), 1066 (symmetric stretching of SO₂), 894 (C—H out-of-plane deformation for p-substituted benzene), 663 (out-of-plane ring bending), 651 (CBr stretching) cm⁻¹. The melting temperature of DBBDSA-BTMA was 198° C., measured by DSC.

### Synthesis of 1,4-dibromo-2,5-benzenedisulfonic acid, dilithium salt (DBBDSA-Li)

DBBDSA-BTMA was dissolved in D.I. water and ion-exchanged to the acid form and the collected aqueous acidic solution was titrated with aqueous LiOH solution to pH 7 while stirring. The water was evaporated and the solid was vacuum dried at 90° C. for 1 day. Yield was 99%. ¹H-NMR (D₂O): δ=8.14 ppm (s, 1H); ¹³C-NMR (D₂O): δ=118.3 (C—Br), 135.2 (C—H), 144.8 ppm (C—SO₃H); FT-IR (KBr pellet): 3103 (aromatic C—H stretching), 1438 (C—C ring stretching), 1317 (in-plane bending), 1209 (asymmetric stretching of SO₂), 1081 (symmetric stretching of SO₂), 898 (C—H out-of-plane deformation for p-substituted benzene), 673 (out-of-plane ring bending), 640 (C—Br stretching) cm⁻¹. A melting temperature was not detected; it decomposed about 270° C.

### Synthesis of 1,4-dibromo-2,5-benzenedisulfonic acid, ditetrabutylphosphonium (TBP) salt (DBBDSA-TBP)

DBBDSA-BTMA was Dissolved in D.I. Water and Ion-Exchanged to the Acid Form. The collected aqueous acidic solution was titrated with aqueous tetrabutylphosphonium hydroxide solution (40 wt %) to pH 7 while stirring. DBBDSA-TBP started to precipitate from the aqueous solution at about pH 4˜5. After reaching pH 7, the white solid was filtered using a Büchner funnel, washed with THF (tetrahydrofuran), and dried under vacuum at 90° C. for 1 day. Yield: 98%. ¹H-NMR (DMSO-d₆, 300 MHz): δ=7.80 ppm (s, 2H), δ=1.92˜2.02 ppm (m, 8H), δ=1.16˜1.30 ppm (m, 16H), δ=0.71 ppm (t, 12H, J=12 Hz); FT-IR (KBr pellet): 3095 (aromatic C—H stretching), 2958, 2939 and 2875 (aliphatic C—H stretching), 1470(—CH₂— vibration and —CH₃ deformation), 1304 (in plane ring bending), 1223 (asymmetric stretching of SO₂), 1064 (symmetric stretching of SO₂), 925 (C—H out-of-plane deformation for p-substituted benzene), 657 (out-of-plane ring bending), 646 (C—Br stretching) cm. The melting temperature was 168° C.

### Synthetic procedures for poly(p-phenylene-2,5-disulfonic acid) (PPDSA): Ullmann coupling reaction

6 g of DBBDSA-Li (14.71 mmole), dried at 100° C. for 2 days under vacuum, was placed in a 500 ml 3-necked round bottom flask and a condenser and rubber septa were fitted to the flask. During activation of the copper powder, the entire system was purged with dried Ar gas for about 30 mins. 9 g of freshly prepared activated copper powder (141.64 mmole) was transferred to the reaction flask and the entire system was kept under vacuum (about 10⁻³ mm Hg) for 1 hour after 2 cycles of Ar gas purging and vacuum evacuation. After releasing vacuum by Ar gas purging, a glass mechanical stirring rod with a Teflon paddle and a lubricated Trubore glass joint were fitted to the flask under Ar gas purging, and 300 ml of freshly distilled and degassed DMF was added to the flask under Ar gas flow using a double-tipped needle. The monomer was allowed to dissolve at around 70° C. A stirring speed of about 45 rpm was used in this part; it was then set to 100 rpm and the temperature was raised to 135° C. After 7 days, the reaction mixture was allowed to cool to room temperature under Ar gas purging. The mixture of unreacted copper and precipitated polymer was filtered. Greenish white low molecular weight polymer was precipitated from the concentrated DMF solution by adding ˜300 mL ethanol; the precipitate was dissolved in D.I. water and the solution was passed through an acidic cationic exchange resin column to protonate the sulfonic acid groups. The collected aqueous polymer solution was titrated with aqueous NaOH solution to pH 7 by checking with pH paper. Low molecular weight disodium salt polymer was obtained as a precipitate after the solution was poured into ethanol (about 10 times the volume of aqueous solution). The yield of low molecular weight polymer was about 33%. The fraction insoluble in DMF was dissolved in D.I. water (˜600 mL); the aqueous solution was separated from the remaining solid by centrifugation and concentrated to ˜50 mL. Strings of high molecular weight polymer formed when the aqueous solution was poured in acetone (˜500 mL, 2 times). The disodium salt was ion-exchanged to the acid form. It was then titrated with aqueous NaOH solution to pH 7, and poured into ethanol (about 10 times to volume of aqueous solution) to precipitate the polymer. The yield of high molecular weight poly(p-phenylene-2,5-disulfonic acid) (PPDSA) was about 55%.

The polymer structure was confirmed using ¹H- and ¹³C-NMR. ¹³C NMR (600 MHz, in D²O): δ=130.62 (C—C in 1 and 4 position of aryl), δ=136.62 (C—H in 3 and 6 position of aryl), δ=141.88 (C—SO₃H in 2 and 5 position of aryl). The ¹HNMR spectrum of the polymer will be shown in Results section and discussed in the Discussion section. Polymer films were made by casting from aqueous solution on a silanized glass plate and evaporating the water.

### Results

### Synthesis of DBBDSA

### Reaction Conditions for DBBDSA Synthesis

Several sulfonation conditions for DBBDSA are listed in Table 2.5. Yields were calculated using the weight of the two compounds isolated after Soxhlet extraction. The desired monomer is the para-substituted material (DBBDSA-Na, 1,4-dibromo-2,5-dibenzene-sulfonic acid, disodium salt). The disulfonation of 1,4-dibromobenzene (DBB) was studied by changing three experimental factors; reaction temperature, reaction time and molar ratio of [SO₃ (g)]/[DBB]. The highest yield using best reaction conditions was 38%.

To select the best polymerization conditions, several salts of the DBBDSA monomer were made from DBBDSA-Na using cation exchange, with high yield: DBBDSA-Li (dilithium slat), -BTMA (dibenzyltrimethylammonium salt) and -TBP (ditetrabutylphosphonium salt).

TABLE 1

| | | | | | | | | Yield of |
|---|---|---|---|---|---|---|---|---|
| | | | | | | | Yield of p- | m- |
| | | Reaction | | | 15% | | substituted | substituted |
| | Reaction | Time | | DBB | Oleum | [S03]/ | compound | compound |
| Lot # | Temp. (° C.) | (hours) | DBB (g) | (mmole) | (mmole) | [DBB] | (%) | (%) |
| 1 | 120 | 72 | 1.93 | 8 | 291 | 5.3 | 10% | 51% |
| 2 | 180 | 24 | 1.93 | 8 | 291 | 5.3 | 19% | 56% |
| 3 | 225 | 24 | 4.09 | 17 | 621 | 5.6 | 28% | 25% |
| 4 | 225 | 10 | 4.09 | 17 | 388 | 3.5 | 34% | 48% |
| 5 | 225 | 24 | 7.94 | 33 | 776 | 3.5 | 37% | 30% |
| 6 | 225 | 24 | 32.02 | 133 | 3103 | 3.5 | 29% | 39% |
| 7 | 225 | 24 | 32.02 | 133 | 2191 | 2.5 | 38% | 30% |
| 8 | 225 | 24 | 64.04 | 266 | 4383 | 2.5 | 32% | 43% |
| 9 | 225 | 24 | 32.02 | 133 | 1920 | 2.2 | 35% | 22% |

Sulfonation conditions and yields: DBB and 15% oleum are 1,4-dibromo-benzene and fuming sulfuric acid (SO3 gas content was about 15%), respectively. The p-and m-substituted DBB are 1,4-dibromo-2,5-dibenzenesulfonicacid, disodium salt and 1,4-dibromo-2,6-benzenedisulfonic acid, disodium salt, respectively. The reaction temperature was the bath temperature.

### Characterizations of DBBDSA

The chemical structures of the monomer salts were characterized using ¹H- and ¹³C-NMR and FT-IR. As the monomer structures had perfect symmetry; there were only one kind of proton and three kinds of carbon on the dibromobenzene ring. Monomers have one proton peak in their spectra (DBBDSA-Na, -Li, BTMA and -TBP. There are three peaks in the each of the ¹³C-NMR spectra of DBBDSA-Na and DBBDSA-Li. They have the same chemical shifts. FT-IR spectra for all the monomers showed the characteristic SO₂ stretching peak; an asymmetric stretching of SO₂ at 1223 cm⁻¹ in the reported range of 1209 to 1230 cm⁻¹ and a symmetric stretching of SO₂ 1080 cm⁻¹ in the reported range of 1060 to 1081 cm⁻¹. The characteristic C—H deformation in para-substituted benzene, 908 cm⁻¹ for the monomer, was within the 894 to about 925 cm⁻¹ range. Based on these results, the chemical structures of the salt forms of DBBDSA are confirmed.

### Synthesis for PPDSA

### Polymerization Conditions for PPDSA

The Ullmann coupling reaction conditions for PPDSA are listed in Table 2. A pretest lot was designed to test the compatibility of conterions on the Ullmann coupling of the DBBDSA monomer. To make high molecular weight polymer, different conditions were used in the polymerization.

TABLE 2

| | | | | | Conct. | |
|---|---|---|---|---|---|---|
| | | | | | Of reaction | |
| | Salt form of | | Reaction | Reaction | system | Type of |
| Lot | DBBDSA | Solvent | Temp. (° C.) | Time | (mole/L) | stirring |
| pretest | BTMA | NMP | 130 | 20 hours | 0.10 | magnetic |
| Lot 1 | BTMA | NMP | 135 | 31 hours | 0.18 | mechanical |
| Lot 2 | TBP | NMP | 135 | 7 days | 0.22 | mechanical |
| Lot 3 | Li | DMF | 135 | 7 days | 0.05 | mechanical |

Polymerization conditions for PPDSA using Ullmann coupling. BTMA and TBP are benzyltrimethylammonium and tetrabutylphosphonium salts, respectively. The stirring speed was 100 rpm for all lots.

Polymers from lots 1 and 2 precipitated from the reaction solvent during polymerization. A high molecular weight polymer from lot 3 was collected from a fraction insoluble in cold DMF (yield: 55%) and a lower molecular weight polymer fraction was obtained from the DMF solution (yield: 33%). Viscosities of the collected polymers from lots 1, 2 and 3 were measured and their reduced viscosities are listed in viscosity results section.

### Rheological Properties

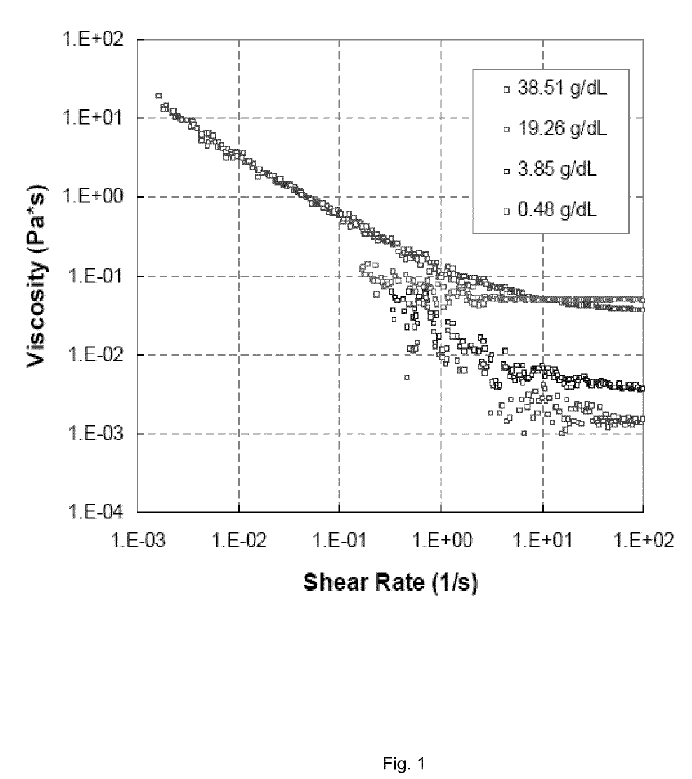

Rheograms for aqueous PPDSA solutions at different concentrations were taken and are shown in FIG. 1. Because PPDSA is rigid rod liquid crystalline polymer, a polymer solution at 38.51 g/dL shows characteristic shear rate dependent viscosity and has two regions (the shear thinning and Newtonian plateau) in its viscosity-shear rate plot. However, the effect of polymer solution concentration on the shear rate dependent viscosity could not be studied. When the polymer solutions were diluted to the range of 0.48˜19.26 g/dL, viscosities measured below 0.1 s⁻¹ were scattered; the rheometer had reached its sensitivity limit.

### PPDSA Viscosity Results

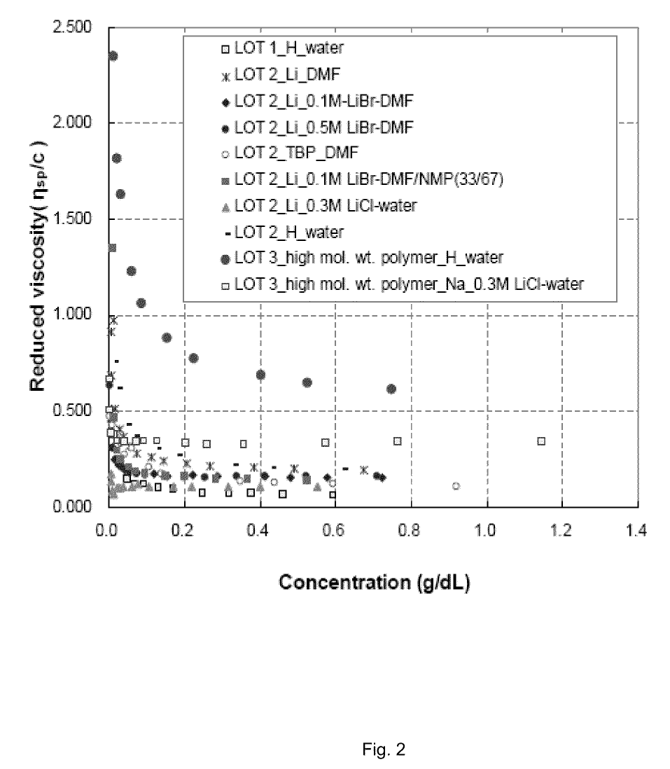

The PPDSA solutions have an abnormal upturn of the reduced viscosity with decreasing concentration independent of the cation species, solvent or salt concentration (FIG. 2). The reduced viscosities are almost constant at high concentration and rise at low concentration. The effects of shear rate, salt concentration, solvent, and cation species on the reduced viscosity will be shown in this section.

### Effect of Shear Rate

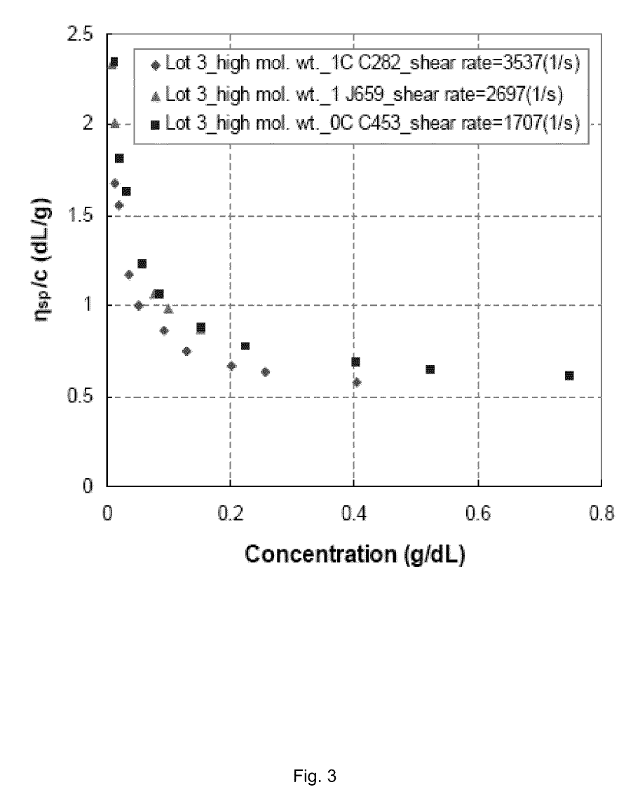

The effect of shear rate on the reduced viscosity was studied using viscometers having different shear rates (3537, 2697 and 1707 s⁻¹) in D.I. water. A plot of viscosity vs. shear rate for an aqueous solution of high molecular weight lot3 PPDSA in water is shown in FIG. 3. This plot shows that, as would be expected for high molecular weight rigid rod materials, the measured viscosity decreases as the shear rate increases.

### Effect of Salt Concentration on Viscosity

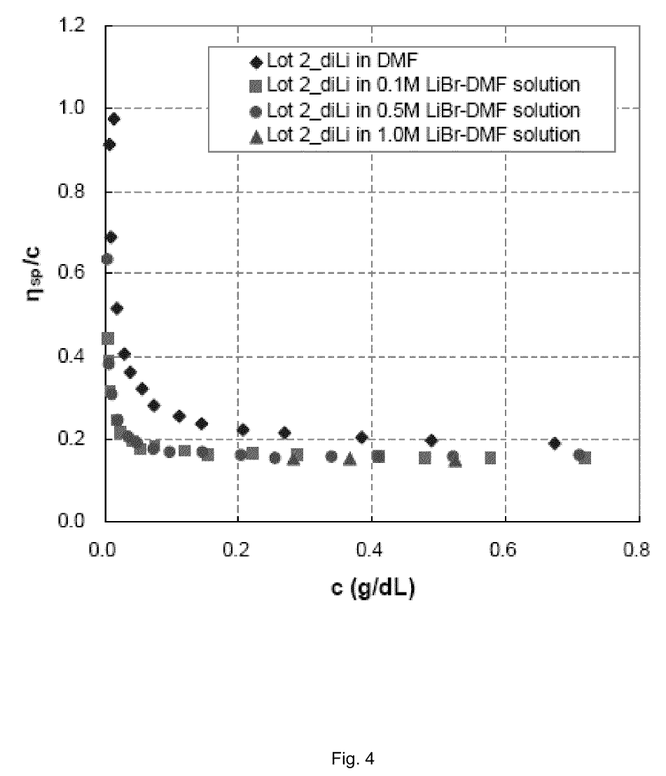

The salt concentration effect on the reduced viscosities of PPDSA was studied in DMF. When a salt solution (LiBr in DMF) was used, the reduced viscosity of lot 2 PPDSA, decreased due to the shielding of the sulfonic acids on the polymer backbone by the added salt (FIG. 4).

Polymer-salt solutions with lithium salt concentrations between 0.1 and 1.0 M have almost constant reduced viscosities in the concentration range 0.2 to 0.6 g/dL, solutions.

### Effect of Solvent

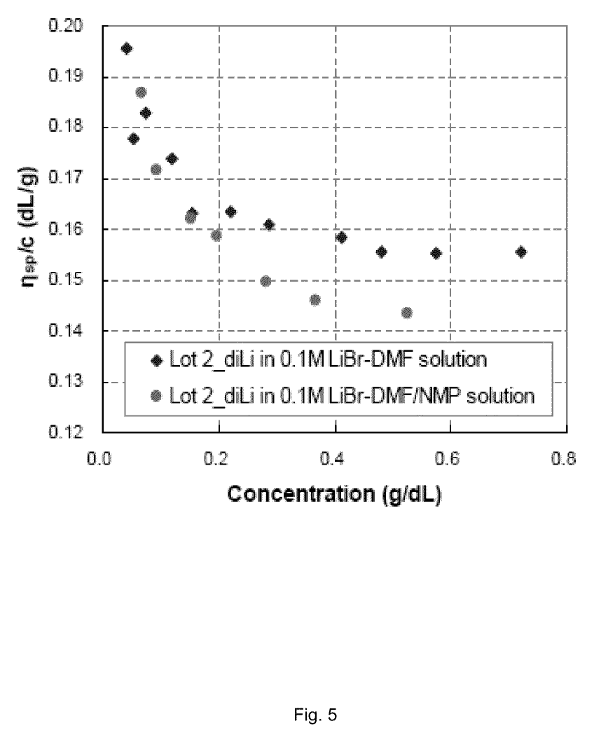

The reduced viscosities of lot 2 PPDSA in 0.1M LiBr-DMF and -DMF/NMP (33/67, v/v) solutions were measured using the same experimental conditions (polymer sample, cation species, salt concentration, viscometer and temperature) (FIG. 5). The effect of solvent is small, but, the reduced viscosity of polymer in DMF is slightly higher at high concentration.

### Effect of Cationic Species

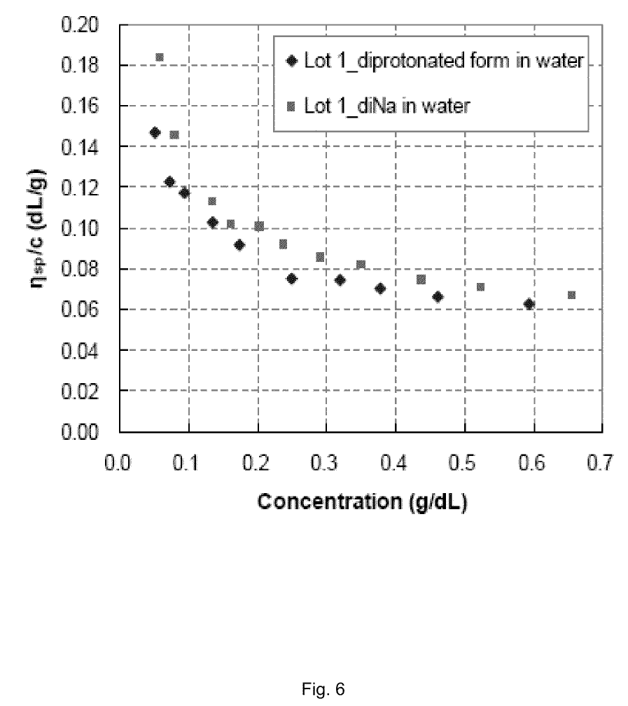

The reduced viscosities of PPDSA (lot 1), diprotonated form and disodium salt were measured under the same conditions. The effect of cation (protonated form vs. sodium salt) on the reduced viscosity of PPDSA is small (FIG. 6).

### Effect of Polymer Molecular Weight

The reduced viscosities of diprotonated high and low molecular weight polymers of lot 3 are compared with diprotonated lot 2 and lot 1. The reduced viscosities at about 0.40˜0.44 g/dL were 0.68 dl/g (high molecular weight polymer in lot 3), 0.26 dl/g (low molecular weight polymer in lot 3), 0.21 dl/g (lot 2), and 0.07 dl/g (lot 1).

### Evaluation of Water Uptake and Lambda (λ)

To decide the minimum storage time needed for equilibrating at controlled relative humidities, the weight changes of the polymer films were monitored for 6 days. In all the tested relative humidities (15 to 75% RH), the weights were constant after one day's equilibration. So the equilibration time in the humidity chambers was fixed at 1 day. The lot 3 low molecular weight polymer (from soluble fraction) has a viscosity similar to that of the polymer made in NMP, lot 2 that precipitated during polymerization.

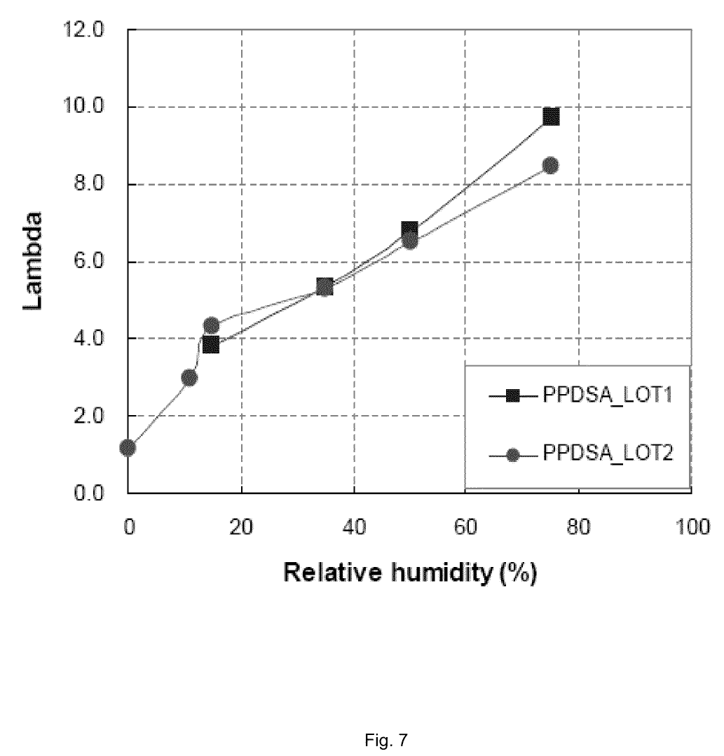

The water uptake test at different humidities was carried out using the pre-established drying conditions and equilibrium time; the results are shown in Table 3. Two lots of PPDSA films (lots 1 and 2) were studied for the effect of polymer molecular weight on lambda (FIG. 7). Even though lot 2 had a higher molecular weight and higher reduced viscosity (about 3 times that of lot 1, in viscosity results section), λ for both lots was identical within experimental error from 15 to 50% RH. But, at 75% RH, lot 1 polymer absorbed more water than lot 2 polymer. This could be because the lower molecular weight polymer was more soluble (greater ΔS of mixing).

TABLE 3

| | | | | [SO₃H] | |
|---|---|---|---|---|---|
| % RH | W₁ (g)*¹ | W₂ (g)*² | W₂ − W₁ (g)*³ | (mole)*⁴ | Lambda*⁵ |
| 11 | 0.0164 | 0.0203 | 0.0039 | 1.20E−04 | 3.0 |
| 15 | 0.0471 | 0.0662 | 0.0191 | 3.38E−04 | 4.3 |
| 35 | 0.0480 | 0.0734 | 0.0254 | 3.42E−04 | 5.3 |
| 50 | 0.0517 | 0.0876 | 0.0359 | 3.74E−04 | 6.5 |
| 75 | 0.0547 | 0.1064 | 0.0517 | 3.95E−04 | 8.5 |
| 100 | 0.0522 | 0.2226 | 0.1704 | 3.72E−04 | 26.7 |

Water uptake and lambda evaluation for PPDSA (lot 2).
*¹W₁: the weight of the dried sample;
*²W₂: the weight of the equilibrated sample;
*³weight of absorbed water = W₂ − W₁;
*⁴[SO₃H] was measured by titration with the standardized aqueous NaOH solution;
*⁵Lambda (λ) = 1.2 (λ of the dried film) + [(W₃ − W₂)/18]/[SO₃H]].

Dimensional Changes with Water Uptake

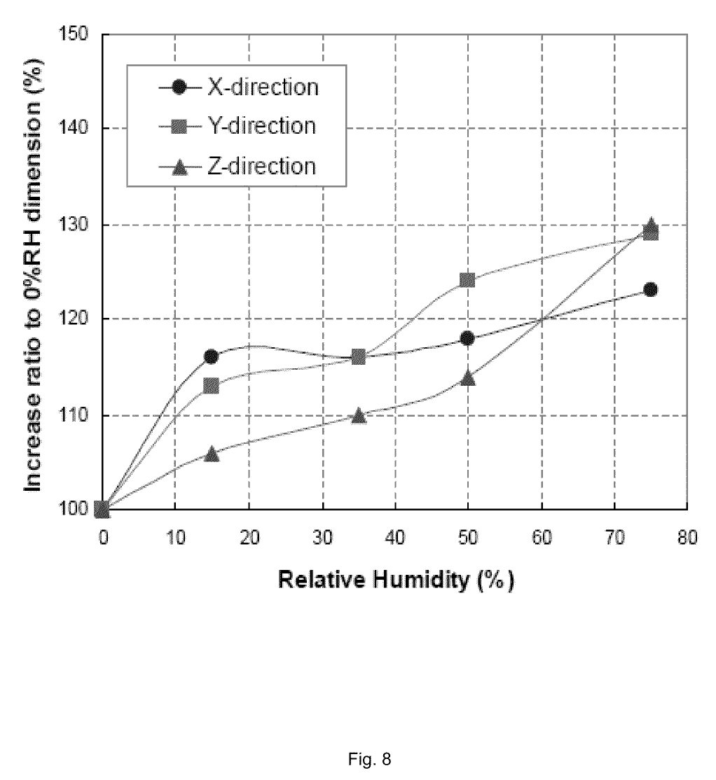

The dimensional changes of PPDSA in three directions at different relative humidities are summarized in Table 4. To compare the degree of dimensional change at different humidities with each other, data are normalized to the dimensions of the dried film for the 15% RH test condition, shown in Table 5. PPDSA does not expand isotropically (FIG. 8). From 15 to 50% RH, the X and Y directional changes are almost double the changes in the Z direction. At 75% RH, the expansion was 23% in the X direction, 28% in the Y direction and 30% in the Z direction compared to that at 0% RH. The volume of the equilibrated film sharply increased from 0 to 15% RH and doubled its original volume at 75% RH.

TABLE 4

| | Dimensions dry (before equilibration) | | | | Dimensions after equilibration | | | |
|---|---|---|---|---|---|---|---|---|
| Direction | 15% RH | 35% RH | 50% RH | 75% RH | 15% RH | 35% RH | 50% RH | 75% RH |
| X direction | 1.80 | 2.22 | 2.17 | 1.78 | 2.08 | 2.58 | 2.55 | 2.19 |
| (mm) | | | | | | | | |
| Y direction | 2.47 | 2.65 | 2.34 | 3.17 | 2.80 | 3.08 | 2.90 | 4.07 |
| (mm) | | | | | | | | |
| Z direction | 397 | 404 | 378 | 427 | 423 | 443 | 430 | 554 |
| (um) | | | | | | | | |

TABLE 5

| | Relative | | | | |
|---|---|---|---|---|---|
| | humidity | | | | |
| | 0% RH | 15% RH | 35% RH | 50% RH | 75% RH |
| Lambda | 1.2 | 4.3 | 5.3 | 6.5 | 8.5 |
| X direction | 100% | 116% | 116% | 118% | 123% |
| Y direction | 100% | 113% | 113% | 124% | 128% |
| Z direction | 100% | 106% | 106% | 114% | 130% |
| Volume | 100% | 139% | 139% | 166% | 205% |

Dimensional changes of PPDSA (lot 2) at different humidities;
(Table 4) in length (mm or um) and (Table 5) as % of dried film dimensions. The X and Y directions are perpendicular and parallel to the casting direction, respectively. The Z direction is the thickness direction.

### Differential Scanning Calorimetry (DSC)

Before running DSC measurements on our conditioned films, the heat of melting and vaporization of bulk water was studied. The theoretical heat of melting and vaporization are 333.5 J/g and 2838 J/g. Our measured heats of melting and vaporization of bulk water were 309.7 J/g and 2125 J/g. Since these are close to the reference values, it showed that the experimental setup was adequate.

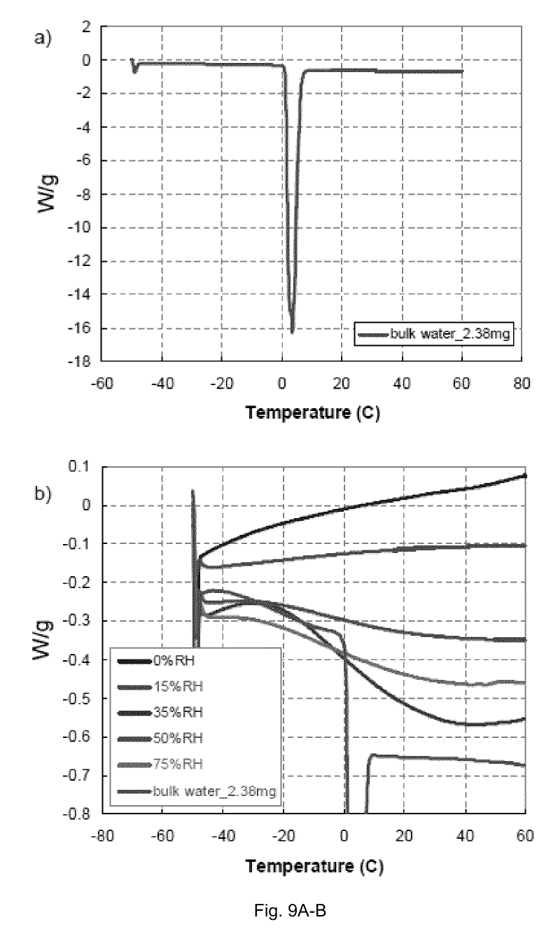

Chilled PPDSA films humidified between 15 and 75% RH had no endothermic peak between −50 to 10° C. (FIG. 9). The absorbed water molecules do not freeze even at −50° C.

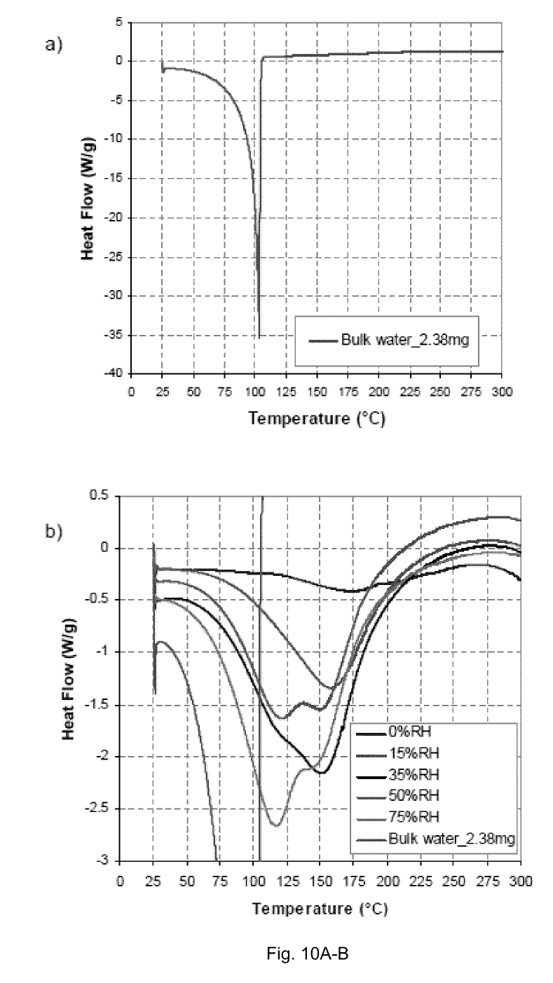

High temperature scans were also run on the PPDSA films (FIG. 10). The curves have endotherms at 111˜120° C. and 152˜160° C. Endothermic shoulders above 240˜250° C. correspond to the decomposition of sulfonic acid groups.

### Thermogravimetric Analysis (TGA)

PPDSA has high a decomposition temperature (about 304° C.) and loss about 13% of its weight before decomposition. Above 304° C., decomposition proceeds rapidly and about 48% are lost compared to the initial weight. The weight loss up to 304° C. corresponds to about one water molecule per sulfonic acid (λ of dried film=1.2); the second weight loss corresponds to the decomposition of sulfonic acids on the polymer backbone.

### Wide Angle X-Ray Diffraction (WAXD)

### WAXD Sample Preparation Method

In order to obtain reliable WAXD data, the humidified polymer needed to maintain its water content during the measurement, and the equilibration should allow the sample to expand freely to its equilibrium dimension.

Several materials were examined for sealing the humidified polymer sample to get reproducible WAXD data. A pre-test control run was made by stacking two sheets of sealing material without polymer film and recording their diffraction pattern using the parameters given in Table 6. Mylar films (Mylar® C) were provided by Dupont Tenijin Films Company. Because Mylar (PET) and Kapton (polyimide) films have some degree of crystallinity, even if the thickness is very thin (Mylar® C: ˜4.5 um), any PPDSA diffraction peaks could be concealed under the intense peaks from the sealing polymer. Cover glass (˜100 um) was a possible sealing material. But, its thickness (˜100 um) and composition (SiO₂) generated so much scattering that the PPDSA peaks could not be seen cleanly. Finally, PVC was found to be the most suitable sealing material for maintaining the humidity of sample while obtaining high quality data. This sealing material was also used for sample preparations in the 2 dimensional X-ray and the optical polarizing microscopy experiments.

TABLE 6

| Parameters | Setting Values |
|---|---|
| Start angle (°) | 0.2 |
| Stop angle (°) | 35 |
| Power | 30 kV/30 mA |
| Sampling width (°) | 0.1 |
| Scanning Speed (°/min) | 0.5 |
| Div. slit (mm) | 2 |
| Div. H.L. slit (mm) | 5 |
| Rec. slit (mm) | Open |
| Sct. Slit (mm or °) | Open |

WAXD test conditions for studies to select sealing materials. The reflection mode was used.

### WAXD Diffractogram of PPDSA

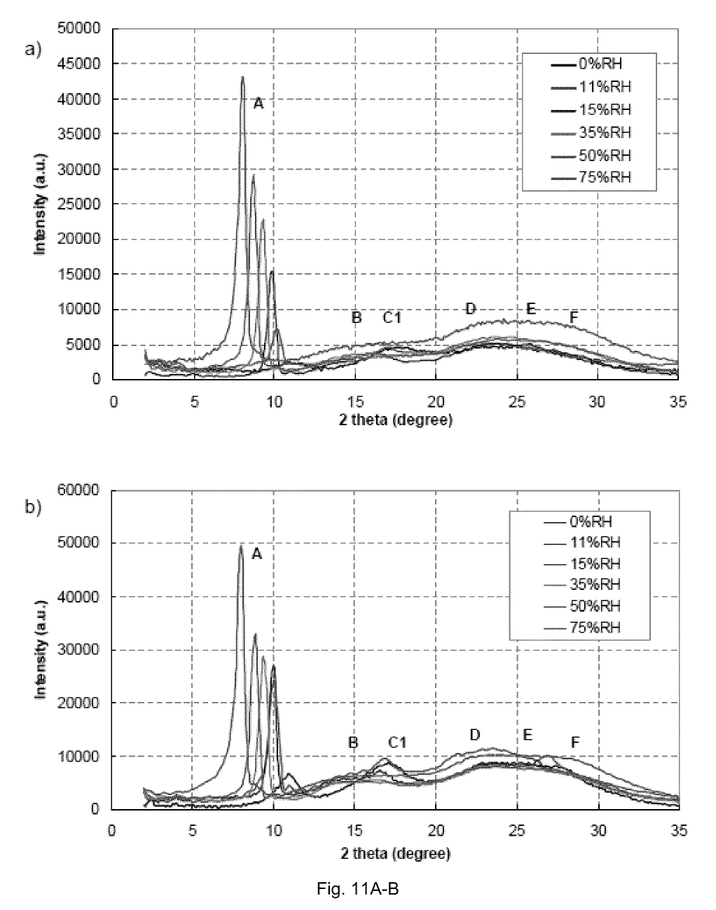

The equilibration of dried film at different humidities and the sealing method used with PVC films for the WAXD experiments were performed in accordance with known procedures. From Table 7 and FIGS. 11 and 12, we can assign six peaks (A, B, C1, D, E, and F) in the transmission mode and six peaks (A, C1, C2, D, E, and F) in the reflection mode. Of all the peaks, only peak A changes with the film water content; the peak positions (20 in WAXD) decrease with increasing relative humidity. The other peaks, (B, C1, C2, D, E, and F), are independent of the water content. Peak A is narrow and large, and thus suitable for analyzing the d spacing change as a function of relative humidity. It is very intense and sharp in the transmission mode and almost nonexistent in the reflection mode. Peak B is broad and shown in the transmission mode. In the reflection mode, it might be concealed by the broad C1 and C2 peaks. The d spacings for the B peaks changed within ˜1 Å. But, when deviations for peaks of B, Table 7, and their breadth are considered, the d spacing changes are within experimental error ranges. The average and standard deviation are 6.15±0.29 (for parallel samples) and 6.25±0.34 (for perpendicular samples) Å).

The peaks C1, C2, D, E and F are easily seen in the reflection mode. In the transmission mode these peaks are very broad and less intense compared to peak A.

TABLE 7

| | | Parallel¹ | | Perpendicular² | |
|---|---|---|---|---|---|
| | % | | d-spacing | | d-spacing |
| Peak | RH | 2theta(°) | (Å) | 2theta (°) | (Å) |
| A | 0 | 10.48 ± 0.3 | 8.44 ± 0.26 | 9 .70 ± 0.4 | 9.12 ± 0.33 |
| | 15 | 9.76 ± 0.2 | 9.07 ± 0.21 | 9.91 ± 0.6 | 8.93 ± 0.49 |
| | 35 | 9.18 ± 0.3 | 9.64 ± 0.30 | 9.21 ± 0.7 | 9.60 ± 0.66 |
| | 50 | 9.01 ± 0.02 | 9.81 ± 0.25 | 8.72 ± 0.6 | 10.15 ± 0.60 |
| | 75 | 7.93 ± 0.05 | 11.16 ± | 8.04 ± 0.3 | 11.00 ± 0.33 |
| | | | 0.60 | | |
| C1 | 0 | 16.90 ± 1.6 | 5.25 ± 0.45 | 16.75 ± 1.4 | 5.29 ± 0.41 |
| | 15 | 16.90 ± 1.5 | 5.25 ± 0.43 | 16.97 ± 1.4 | 5.23 ± 0.41 |
| | 35 | 16.78 ± 1.4 | 5.28 ± 0.40 | 16.75 ± 1.9 | 5.29 ± 0.53 |
| | 50 | 16.80 ± 1.2 | 5.28 ± 0.35 | 16.82 ± 1.4 | 5.27 ± 0.40 |
| | 75 | 16.84 ± 1.3 | 5.27 ± 0.36 | 16.90 ± 0.9 | 5.25 ± 0.26 |
| C2 | 0 | 18.71 ± 0.8 | 4.74 ± 0.18 | 18.57 ± 1.3 | 4.78 ± 0.31 |
| | 15 | 18.66 ± 0.7 | 4.75 ± 0.16 | 18.64 ± 0.9 | 4.76 ± 0.22 |
| | 35 | 18.61 ± 0.9 | 4.77 ± 0.22 | 18.72 ± 0.5 | 4.74 ± 0.13 |
| | 50 | 18.68 ± 1.0 | 4.75 ± 0.23 | 18.69 ± 1.2 | 4.75 ± 0.28 |
| | 75 | 18.72 ± 1.0 | 4.74 ± 0.24 | 18.66 ± 0.9 | 4.76 ± 0.22 |
| D | 0 | 23.67 ± 1.3 | 3.76 ± 0.19 | 23.77 ± 1.0 | 3.74 ± 0.15 |
| | 15 | 23.82 ± 1.2 | 3.74 ± 0.17 | 23.83 ± 1.2 | 3.73 ± 0.18 |
| | 35 | 23.39 ± 1.6 | 3.80 ± 0.23 | 24.08 ± 1.3 | 3.70 ± 0.19 |
| | 50 | 23.55 ± 1.3 | 3.78 ± 0.20 | 23.63 ± 1.2 | 3.76 ± 0.18 |
| | 75 | 23.55 ± 1.3 | 3.78 ± 0.19 | 23.59 ± 1.4 | 3.77 ± 0.20 |
| E | 0 | 25.82 ± 1.2 | 3.45 ± 0.16 | 25.78 ± 1.6 | 3.46 ± 0.19 |
| | 15 | 25.77 ± 1.0 | 3.46 ± 0.13 | 25.97 ± 1.7 | 3.43 ± 0.20 |
| | 35 | 25.82 ± 1.0 | 3.45 ± 0.13 | 26.18 ± 1.1 | 3.40 ± 0.13 |
| | 50 | 25.80 ± 1.2 | 3.45 ± 0.16 | 25.89 ± 1.7 | 3.44 ± 0.21 |
| | 75 | 25.78 ± 1.2 | 3.46 ± 0.15 | 26.14 ± 1.5 | 3.41 ± 0.19 |
| F | 0 | 28.87 ± 6.9 | 3.09 ± 0.58 | 29.57 ± 5.4 | 3.02 ± 0.45 |
| | 15 | 28.42 ± 6.1 | 3.14 ± 0.54 | 29.57 ± 5.7 | 3.02 ± 0.48 |
| | 35 | 29.53 ± 4.3 | 3.03 ± 0.37 | 30.66 ± 0.9 | 2.92 ± 0.08 |
| | 50 | 33.40 ± 4.8 | 2.68 ± 0.32 | 29.90 ± 4.9 | 2.99 ± 0.41 |
| | 75 | 30.40 ± 4.0 | 2.89 ± 0.32 | 29.52 ± 2.9 | 3.03 ± 0.26 |

WAXD peak data of PPDSA (lot 2) in a) transmission mode and b) reflection mode.
Note)¹and ²Parallel and perpendicular correspond to the Xray beam to the casting direction.
±deviation in degree was calculated using 0.5*FWHH of each deconvoluted peak, and that in Å was calculated with maximum and minimum of 2θ using Bragg's law.

### 2D X-Ray Diffraction

Two dimensional X-ray diffraction is a very useful technique to characterize the orientation of polymer chains in a film. If polymer chains align, several spots along the equator could possibly be seen in the X-ray rather than a ring. Similarly, repeats along the polymer chain could produce several spots along the meridion.

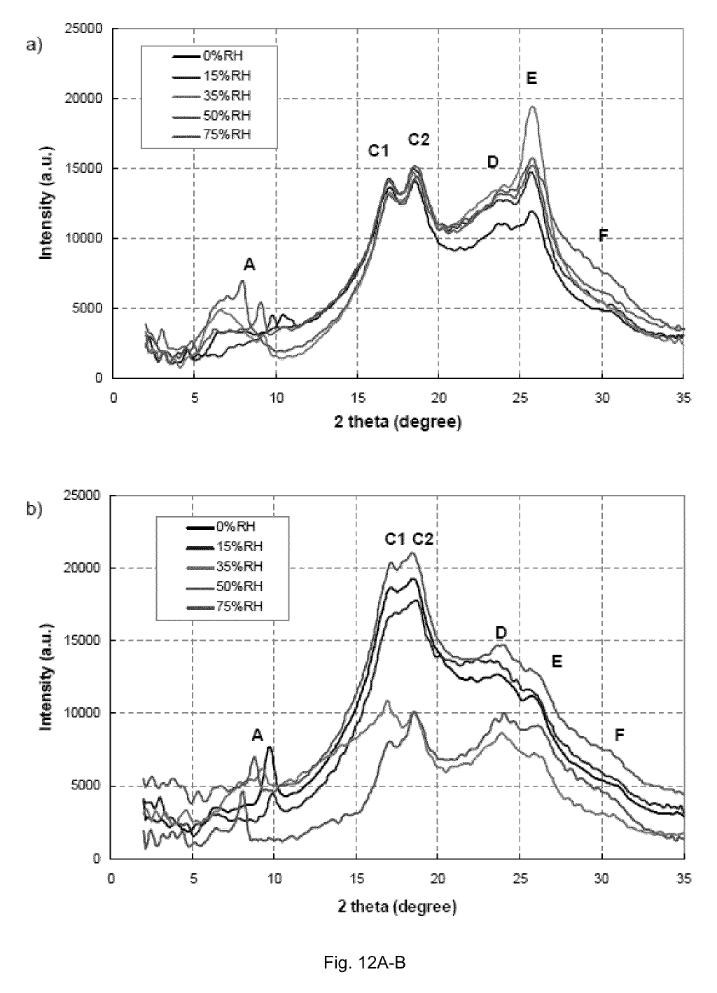

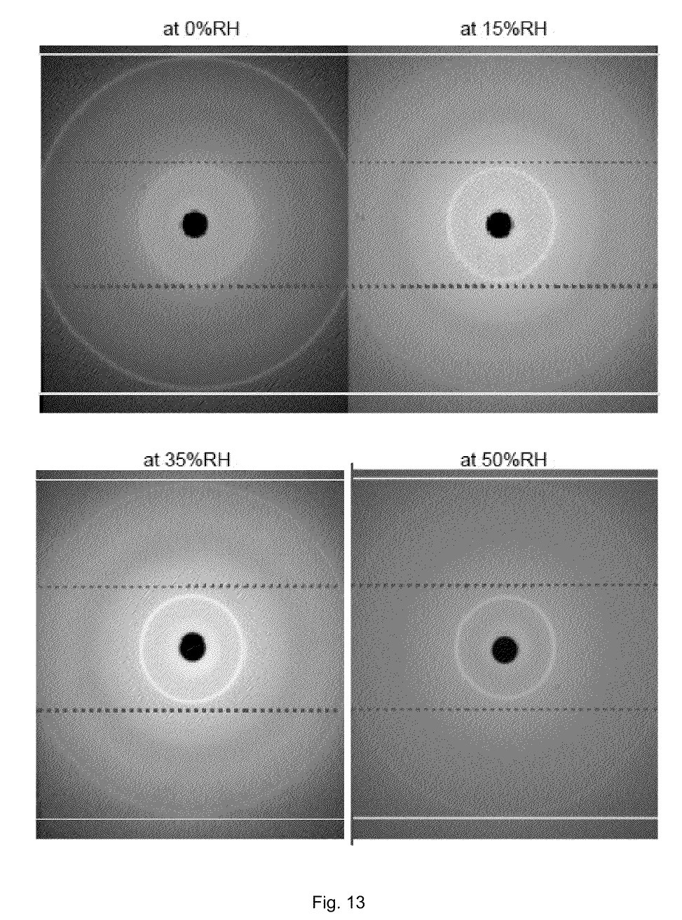

The 2D X-ray spectra of PPDSA at different relative humidities are shown in FIG. 13 and the d spacings of the rings are listed in Table 8. However, all the PPDSA films (at relative humidities from 0 to 75%) show rings for the long spacings instead of spots. The circle dimension for spectra taken at 75% RH was broader than that of the others, probably because the 2D X-ray exposure time (24 hours) for all samples was much longer than for the WAXD test (8 hours), and the high humidity sample could have been slightly dehydrated, changing the d spacing.

TABLE 8

| | Meridional | | Equatorial | |
|---|---|---|---|---|
| | radius of | d-spacing | radius of | d-spacing |
| % RH | ring (mm) | (Å) | ring (mm) | (Å) |
| 0 | 13.98 ± 1.3 | 8.11 ± 0.68 | 13.87 ± 1.3 | 8.17 ± 0.67 |
| 15 | 13.22 ± 0.4 | 8.61 ± 0.25 | 12.89 ± 0.5 | 8.84 ± 0.34 |
| 35 | 12.55 ± 0.4 | 9.04 ± 0.25 | 12.45 ± 0.4 | 9.12 ± 0.30 |
| 50 | 11.49 ± 0.4 | 9.92 ± 0.29 | 11.74 ± 0.4 | 9.71 ± 0.30 |

d spacing (value ± deviation) from 2D X-ray spectra of PPDSA (lot 2) at different humidities.

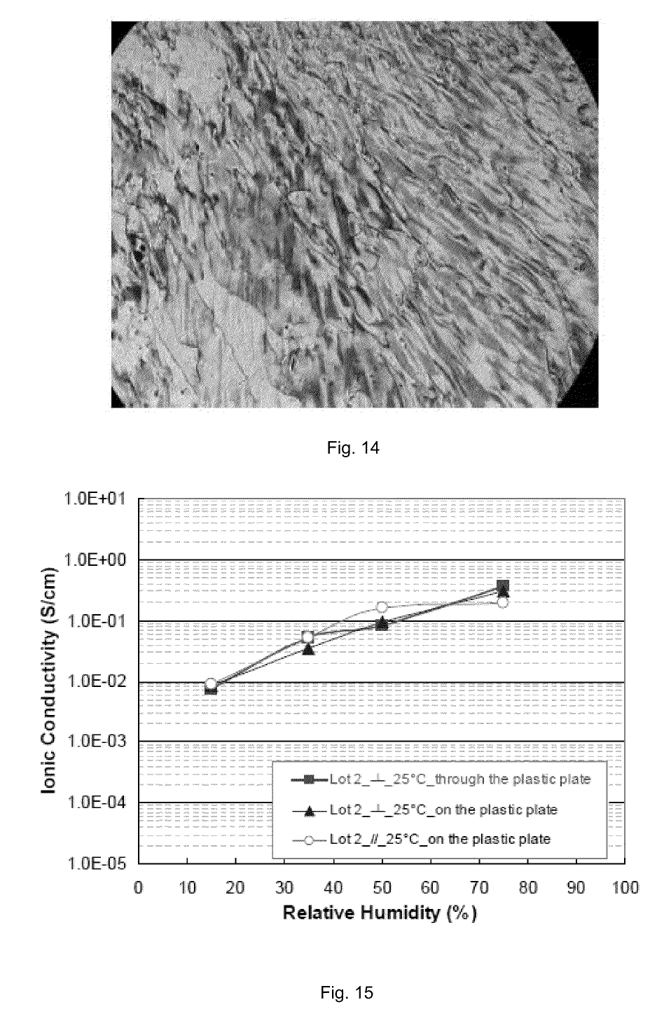

Aqueous solutions of PPDSA are expected to form a lyotropic liquid crystalline phase due to its rigid rod structure. FIG. 14 shows that an aqueous PPDSA solution is lyotropic; it has the typical birefringent Schlieren texture of a nematic liquid crystalline phase.

### Effect of Molecular Weight on the Proton Conductivity

In this section, the conductivity dependence on the polymer molecular weight is studied using PPDSA films from different polymerization lots, shown in Table 9. The proton conductivities of PPDSA film rise with the molecular weight of polymer under the same test conditions (Table 9 and FIG. 15). But, once the polymer molecular weight reaches a certain level, the conductivity does not change much. The order of conductivities is lot 3 (high molecular weight polymer)≈lot 2>lot 1.

TABLE 9

| Temperature | Relative | Conductivity (S/cm) | | |
|---|---|---|---|---|
| (° C.) | humidity (% RH) | Lot 1 | Lot 2 | Lot 3 |
| 25 | 15 | 1.1E−03 | 8.9E−03 | 1.2E−02 |
| | 35 | 5.5E−02 | 5.3E−02 | 5.8E−02 |
| | 50 | 6.5E−02 | 1.6E−01 | 1.1E−01 |
| | 75 | 1.8E−01 | 1.9E−01 | 2.6E−01 |
| 50 | 15 | 1.2E−02 | 3.3E−02 | 4.2E−02 |
| | 35 | 1.8E−01 | 1.5E−01 | 1.8E−01 |
| | 50 | NA | 3.2E−01 | 2.5E−01 |
| | 75 | NA | NA | NA |
| 75 | 15 | 3.1E−02 | 9.2E−02 | 8.7E−02 |
| | 35 | 4.1E−01 | 3.5E−01 | 2.9E−01 |
| | 50 | NA | 1.0E+00 | 4.5E−01 |
| | 75 | NA | NA | NA |

Proton conductivities of PPDSA films from lots 1, 2, and 3 at different conditions. The PPDSA films were cut parallel to the casting direction.

### Effect of the Casting Direction on Conductivity

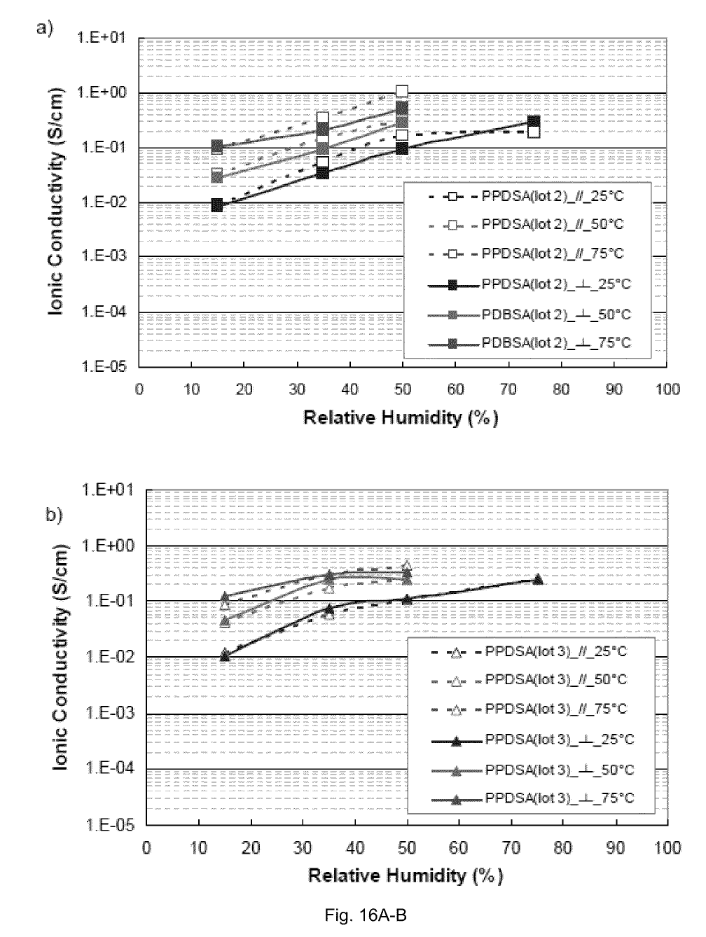

The effect of film casting direction on the conductivity was studied; The results are listed in Table 10 and shown in FIG. 16 since PPDSA is a rigid rod liquid crystalline polymer, chains can be organized with respect to the casting direction and the film properties (conductivity, mechanical properties, etc) could be affected by the degree of orientation. The polymer conductivities (lots 2 and 3) were independent of the X and Y directions. If the rigid rod polymer chain were aligned parallel to the casting direction, the measured conductivities in that direction might be higher than the conductivity at right angles because the proton mobility should be higher parallel to the chain direction. Since the conductivity is independent of the film orientation, PPDSA film is isotropic in the X and Y directions.

TABLE 10

| Tem- | Relative | Conductivity (S/cm) | | | |
|---|---|---|---|---|---|
| per- | humid- | | | Lot 3_high | |
| ature | ity | Lot 2 | | mol. Wt. polymer | |
| (° C.) | (% RH) | Parallel | Perpendicular | Parallel | Perpendicular |
| 25 | 15 | 8.9E−03 | 8.4E−03 | 1.2E−02 | 1.1E−02 |
| | 35 | 5.3E−02 | 3.5E−02 | 5.8E−02 | 7.6E−02 |
| | 50 | 1.6E−01 | 9.4E−02 | 1.1E−01 | 1.1E−01 |
| | 75 | 1.9E−01 | 3.0E−01 | 2.6E−01 | 2.4E−01 |
| 50 | 15 | 3.3E−02 | 2.8E−02 | 4.2E−02 | 4.6E−02 |
| | 35 | 1.5E−01 | 9.5E−02 | 1.8E−01 | 2.4E−01 |
| | 50 | 3.2E−01 | 2.8E−01 | 2.5E−01 | 2.5E−01 |
| | 75 | NA | NA | NA | NA |
| 75 | 15 | 9.2E−02 | 1.0E−01 | 8.7E−02 | 1.2E−01 |
| | 35 | 3.5E−01 | 2.1E−01 | 2.9E−01 | 3.0E−01 |
| | 50 | 1.0E+00 | 5.1E−01 | 4.5E−01 | 3.4E−01 |
| | 75 | NA | NA | NA | NA |

The membrane conductivities of PPDSA films of lots 2 and 3 at different temperatures and humidities. Parallel and perpendicular mean the measuring direction is parallel (or perpendicular) to the casting direction, respectively.

### Mechanical Properties

The mechanical properties of PPDSA were studied using humidified PPDSA films. The dried film was relatively brittle with a high Young's modulus and low elongation at break. Young's modulus as well as the stress and strain at break depend on the relative humidity, reflecting the plasticizing effect of the water molecules in the polymer film. PPDSA equilibrated at 15% RH was brittle with a high break force (6.88 MPa) and Young's modulus (1650 MPa). However, 1.6 GPa is a low modulus for any rigid polymer, much less a liquid crystal polymer. It is should be 5˜20 GPa unless plasticized. As the water contents increased (at 35% RH), modulus is decreased to 30 MPa. The film at 50% RH could not be measured because it dried rapidly under lab condition after 20˜30 mins, and it was too soft to run an accurate test.

### Discussion

### Reaction Conditions for DBBDSA Synthesis

The new monomer, DBBDSA (1,4-dibromo-2,5-benzenedisulfonic acid) was sulfonated using fuming sulfuric acid. Other reagents (concentrated sulfuric acid and chlorosulfonic acid) were also tried, but only meta-substituted material was obtained, or the reaction did not work well.

The method used to make disulfonated DBB needed careful control of the reaction conditions due to the required high temperature. The reaction system was purged with inert gas (Ar gas, purged after drying with molecular sieves (4 Å)). Otherwise, the reactant and product could be oxidized in the highly acidic reaction medium at high temperature by oxygen, and only by-products could be obtained. The purification of disulfonated DBB also had to take into account the high solubility of the product. The normal salting out process uses NaCl to precipitate the sulfonated product. But, disulfonated monomer was very soluble in aqueous solution, and the salting out using NaCl did not work well. So, this disulfonated monomer was salted out by Na₂SO₄ formed by adding Na₂CO₃.

The next consideration was the separation of para-substituted DBB from the mixture of meta- and para-substituted DBB. This purification is very important if one wishes to get high molecular weight polymer through Ullmann coupling. Previous studies reported that a halide meta to the sulfonic acid group was not involved efficiently in the coupling reaction. Unfortunately, these disulfonated compounds are ionic materials and could not be separated using silica gel column chromatography. But, their different solubilities, due to different symmetry of the chemical structures made the para-substituted sodium salt almost insoluble in ethanol and the isomer could be separated using Soxhlet extraction. The extraction process was monitored by a characterization of the solids remaining in the thimble using ¹H- and ¹³C-NMR after extraction for 2˜3 days. This extraction process was repeated until the only desired product was remained in the thimble. Yields of the para- and meta-substituted compounds were calculated after a complete extraction.

Low total yields are possibly due to meta-substituted compound and/or monosulfonated compound remaining soluble in the salting out process. The amount of water-insoluble solid that was filtered before salting out was less than 0.10 g in lot 11. So, most of DBB was consumed in sulfonation. In the salting out process, the para-substituted DBB was expected to crystallize easily from solution since it seems to be much less soluble than the meta-substituted compound. Some fraction of the meta-substituted compound and/or monosulfonated compound (such as 1,4-dibromo-2-benzenesulfonic acid) could stay in solution, The salted out solid had no monosulfonated compound, based on its ¹H-NMR spectrum. However, because the remaining solution after salting out was not analyzed further, we do not know if there was any monosulfonated compound.

Different reaction conditions were studied to increase the yield of DBBDSA (1,4-dibromo-2,5-benzenedisulfonic acid). At conventional temperatures (120° C. and 180° C.) with a mole ratio of [SO₃]/[DBB] (1,4-dibromobenzene) of 5.3, the major product was the metasubstituted material and the minor one was the para-substituted material (yields were about 10 and 19%). When the reaction temperature was increased to 225° C., the yield of para-substituted DBB increased to about 28%. From these results, we can assume that high reaction temperature favors the 2^{nd} sulfonation para to the first sulfonic acid.

The effect of mole ratio of [SO₃]/[DBB] on the yield of para-substituted DBB was tested to determine the best reaction conditions. Reactions for 24 hours using low mole ratios of [SO₃]/[DBB] (3.5 and 2.5) increased the yield of para-substituted DBB to 37˜38%, the highest yield, from that using high mole ratios (5.6). However, when the mole ratio of [SO₃]/[DBB] was reduced to 2.2, the yield did not improve. Therefore, a mole ratio of [SO₃]/[DBB] of 2.5 was a good condition to give the best yield of para-substituted DBB.

The effect of reaction time was tested with a low mole ratio of [SO₃]/[DBB] of 3.5 at 225° C. Longer reaction time (24 hours) had a slightly higher yield than that for a short reaction time (10 hours). But, when the reaction was scaled up the yield dropped to 29%. However, at the lower mole ratio of 2.5, using the same amount of dibromobenzene, the yield of para-substituted DBB increased to 38% (lot 7). A further scale-up gave reasonable yield of parasubstituted DBB (32%). Therefore, the best conditions found (225° C., [SO₃]/[DBB]=2.5, 24 hours) for the synthesis of para-substituted DBB were used in subsequent reactions. DBBDSA salts were polymerized in different organic solvents using activated copper powder. The goal was to make high molecular polymer. Ion exchange provided an easy way to convert one cationic species to another. The ammonium (benzyltrimethylammonium, BTMA) and phosphonium (tetrabutylphosphonium, TBP) salts were used to, hopefully, increase the solubility of the polymer during the coupling reaction. PPSA polymer from earlier reactions (Ullmann coupling of bis(benzyltrimethylammonium) salt of 4,4-′dibromo-3,3′-biphenyl disulfonic acid in NMP) always precipitated during polymerization and it was difficult to obtain high molecular weight.

### Polymerization Conditions for PPDSA Synthesis

The Ullmann coupling reaction between sulfonated biphenyl monomer was tested. At first, the coupling reaction was tested with DBBDSA-BTMA in NMP. But after 1˜2 hours of reaction, all polymer had precipitated even if mechanical stirring was used, and there was no further polymerization. The molecular weight of precipitated polymer was very low (reduced viscosity at 0.2 g/dL of polymer, disodium salt from lot 1 in D.I water at 35° C.: 0.10 dL/g), and a cast film was very brittle.

From these results and the previous results, the solution behavior of polymers made using different cationic species and reaction solvents needed to be studied by viscosity measurements at different concentrations. More results from viscosity measurements will be discussed in the next section. The solubility of resulting polymer with different cations was tested in order to optimize reaction conditions to get high molecular weight polymer. In the Ullmann coupling reaction, the available organic solvents were limited to DMF, DMAC and NMP, and the matching of the salt form of monomer and resulting polymer with the organic solvent during coupling was expected to be the key parameter for production of high molecular weight polymer.

The main reason for using the ammonium (BTMA) or phosphonium (TBP) salt form of DBBDSA was to increase the solubility of the polymer in reaction medium to get high molecular weight polymer. But, solubilities of diBTMA or diTBP salts of the resulting polymers in reaction medium were different from our expectations. The polymer made using DBBDSA-BTMA precipitated during polymerization after about 2 hours; it has the lowest reduced viscosity. The polymer, made using DBBDSA-TBP also precipitated during reaction and had a reduced viscosity similar to the low molecular weight polymer. So, the DBBDSA counterion affects the polymer solubility during the reaction.

The other factor considered for making high molecular weight polymer was the monomer concentration in the reaction system. PPDSA has a sharp increase of viscosity at low concentrations in aqueous or organic solvents, independent of the presence of salt: the viscosity of the polymer at or below 0.1 g/dL is higher than that at about 0.4 g/dL, shown in section 2.4. So, a low concentration of monomer in the reaction medium is important for increasing the polymer solubility during polymerization.

Therefore, the best conditions were determined to be: DBBDSA-Li in dried DMF at a concentration of 0.05 mole/L (2.0 g/dL). These conditions produced the highest molecular weight PPDSA with the highest reduced viscosity found, 0.67 dL/g

### Shear Thinning of PPDSA

The PPDSA aqueous solutions show some degree of shear thinning in the plot of reduced viscosity measured vs. concentration using different viscometers. This plot show that, as would be expected for high molecular weight rigid rod materials, the measured viscosity decreases as the shear rate increases due to shear induced orientation of the rods in solution.

### NMR Spectra of PPDSA

### ¹H-NMR Spectra of PPDSA

The polymer, disodium salt form chemical structure from different polymerizations was studied using ¹H-NMR. There should be one proton peak in the polymer NMR spectrum if the monomer had coupled at the 1 and 4 positions. However, many peaks are observed in the PPDSA ¹H-NMR spectra. To analyze those efficiently, the spectra were deconvoluted using ACD labs Curve processing module (version 9.05).

As the polymer molecular weight increases, two changes can be seen in NMR spectra. The first is the change in the 7.65 ppm peak area (G5), and the number of peaks near 7.65 ppm. In the spectrum, the peak area at 7.65 ppm is relatively large, and three small peaks around 7.65 ppm have visible intensities. As the molecular weight increases, the area of the 7.65 ppm peak diminishes, and the adjacent peaks almost disappear. The area ratios of peaks in G5 (7.5˜7.73 ppm) to peaks from G1 to G4 (8.0˜7.73 ppm change from 0.063 to 0.007. The peaks between 7.5˜7.7 ppm probably belong to protons at the ends of the polymer chain. Xₙs (the number average degree of polymerization) for different lots are calculated using these area ratios: the highest value is 142.

Second is that all the peaks become broader (larger FWHH), as the molecular weight increases. As the polymer molecular weight increases, the molecular relaxation time becomes longer and the peaks become broader. These FWHH changes are expected from the viscosity results.

The ¹H-NMR spectra of PPDSA are not fully understood and a full analysis that could characterize its chain stereochemistry was not undertaken. However, the ¹³C-NMR spectrum, next section, shows that the polymer contains only 1,4-phenylene units.

### ¹³C-NMR Spectrum of PPDSA

The ¹³C-NMR spectrum was very useful for characterizing the polymer chemical structure. Changes in the chemical shifts of peaks a and c confirmed that aromatic coupling reaction between monomers had happened with a loss of Br; 1) The peak c for carbon bonded to Br (118.3 ppm) in monomer disappeared and a new peak c (130.62 ppm) appeared. 2) After coupling, the electron density of carbons connected to the sulfonic acid group slightly increased due to loss of halide, and peak a is shifted about 3 ppm to higher field.

### Water Retention of PPDSA Film at Different Relative Humidities

### Lambda of PPDSA

In the operation of a PEMFC, membrane hydration is critical to the fuel cell performance since it determines proton conductivity, methanol permeability and electro-osmotic drag. However, the degree of water absorption on a mass basis does not correlate well with those properties, especially when comparisons are made between different macromolecular systems. When membrane properties are studied using lambda (λ, the number of water molecules on one sulfonic acid) as a measure of the water retention, the comparison of the proton conductivity and morphological changes with different polymer systems can be more useful.

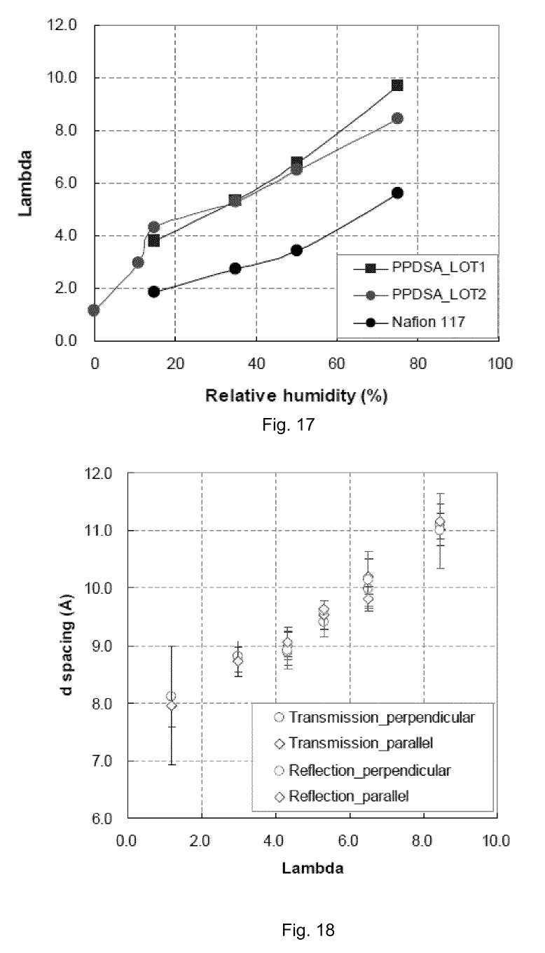

Lambda, λ for different molecular weight PPDSAs was measured at different relative humidities (FIG. 17). λ for both lots was identical within experimental error from 15 to 50% RH. It is reasonable to suppose that both lots had the same supramolecular organization and thus the same water-absorbing ability. The dried film (0% RH) had 1.2 water molecules even after the film was dried under vacuum at 90° C. for 1 day and at 150° C. for 1 hour. These waters are very tightly bound.

The most important result is that PPDSA in this relative humidity range holds almost two more water molecules per sulfonic acid than Nafion 117, due to its high sulfonic acid concentration (=low equivalent weight (Eq. wt.) of 118.13 g/[SO₃H] and frozen-in free volume. Because the proton conductivity in such membranes is strongly dependent on lambda (i.e. water content), which is the medium for proton transport, high lambda at low humidity is a key property needed to improve Fuel Cell performance.

The state of water in PPDSA films was studied using low and high temperature scanning DSC measurements. Equilibrated PPDSA films from 15 to 75% RH had no endothermic peak in the low temperature scans from −50 to 60° C. This result is very interesting because PPDSA that was equilibrated at 75% RH had about 9 water molecules per acid group. Both the Nafion and

BPSH-40 started showing endothermic peaks at λ˜7. This is a very important result for low temperature applications of PEMFC because the operating conditions for vehicle are sometimes below −20° C. In fact, to get high conductivity using synthetic polymeric membrane and Nafion, high humidity was essential factor. The large amount of free water in the membrane can increase not only the proton conductivity but also the electro-osmotic drag coefficient. This is not good for long-term Fuel Cell performance due to poor water management. PPDSA is a potential candidate for PEMFC and meets the protonic conductivity targets proposed by U.S. Department of Energy.

The high temperature scanning curves had endotherms with maxima at 111˜120° C. and 152˜160° C. The scanning results from 100 to 150° C. are much more important than the low temperature scanning results. High temperature operation is essential to decrease the poisoning of Pt catalyst. But, Nafion and most of the other reported membranes had a sharp drop of proton conductivity at high temperature due to the loss of water. However, PPDSA has high water affinity above 120° C., based on these DSC results and should meet or exceed the DOE protonic conductivity targets.

Tightly bound water molecules (λ˜1.2) could also be seen in these results. These did not freeze down to −50° C., but vaporized above 150° C. A TGA thermogram of the dried film showed the strongly bound water. The first weight loss before decomposition (about 304° C.) was about 13%, corresponding to the loss of one water molecule.

These DSC thermograms confirmed that there is no free water in the humidified PPDSA films, up to 75% RH. The binding strengths of the water molecules in humidified PPDSA can be divided into two regions. Based on these results, it is possible that PPDSA may have an electro-osmotic drag coefficient less than 1 between 15 to 75% RH, combined with high proton conductivity.

### The Presence of Frozen-in Free Volume in PPDSA

Lambda is in PPDSA about two higher than in Nafion 117 between 15 and 75% RH. These absorbed water molecules (λ˜8.5) were tightly bound in the polymer (no endotherm showing weakly bound or free water) based on the DSC results. In this section, possible reasons for the high water retention of PPDSA will be discussed.

In the first part, macroscopic studies using the dimensional and weight changes of films at different humidities will be discussed. The second part will cover the microscopic studies using the X-ray data and a packing model study.

### Macroscopic Studies

### Dimensional Changes of PPDSA Film at Different Humidities

Membrane dimension stability is a very important part of a robust design for a fuel cell. Because the membrane-electrode assembly (MEA) is put in a sandwich structure of two gas diffusion layers and bipolar plates, fuel cell membranes must have dimensional stability under a variety of conditions (e.g. high temperature and high humidity).

PPSA made earlier in our lab had a lamellar structure in the solid state, and the homopolymer had a large expansion in thickness (at 75% RH and room temperature, 80% increase in thickness direction, and 5 and 6% increase in other directions compared to the dimensions at 15% RH). The unique solid state structure was deduced from its anisotropic expansion.

However, PPDSA expands almost isotropically. At 75% RH, the expansion was 23% in the X direction, 28% in the Y direction and 30% in the Z direction compared to the dimensions at 0% RH. To study the dimensional changes, these individual experimental data points at a specific humidity were normalized to the dried film dimensions at 15% RH; they are listed in Table 11.

TABLE 11

| | Measure before humidification | | | | Measure after humidification | | | |
|---|---|---|---|---|---|---|---|---|
| Dimension | 15% RH | 35% RH | 50% RH | 75% RH | 15% RH | 35% RH | 50% RH | 75% RH |
| X direction | 1.80 | 2.22 | 2.17 | 1.78 | 2.08 | 2.58 | 2.55 | 2.19 |
| (mm) | | | | | | | | |
| Y direction | 2.47 | 2.65 | 2.34 | 3.17 | 2.80 | 3.08 | 2.90 | 4.07 |
| (mm) | | | | | | | | |
| Z direction | 397 | 404 | 378 | 427 | 423 | 443 | 430 | 554 |
| (um) | | | | | | | | |
| Volume | 1.77 | 2.37 | 1.91 | 2.41 | 2.46 | 3.52 | 3.17 | 4.94 |
| (cc) | E−03 | E−03 | E−03 | E−03 | E−03 | E−03 | E−03 | E−03 |

b)

| | |
|---|---|
| | Normalized volume of |
| Volume of film (cc) | film (cc) |

| Relative | | before | after | Normalization | before | after |
|---|---|---|---|---|---|---|
| humidity | λ | equilibrium | equilibrium | factor | equilibrium | equilibrium |
| 0% RH | 1.2 | 1.77E−03 | 1.77E−03 | | 1.77E−03 | 1.77E−03 |
| 15% RH | 4.3 | 1.77E−03 | 2.46E−03 | | 1.77E−03 | 2.46E−03 |
| 35% RH | 5.3 | 2.37E−03 | 3.52E−03 | | 1.77E−03 | 2.62E−03 |
| 50% RH | 6.5 | 1.91E−03 | 3.17E−03 | | 1.77E−03 | 2.93E−03 |
| 75% RH | 8.5 | 2.41E−03 | 4.94E−03 | | 1.77E−03 | 3.62E−03 |

Dimensional changes of PPDSA (lot 2) at different humidities. a) Original data, b) data normalized to the dimensions of the dried film for 15% RH, The X and Y directions are perpendicular and parallel to the casting direction, respectively. The Z direction is the thickness direction.

### Microscopic Studies

### Analysis of X-Ray Diffractogram of PPDSA

The determination of the solid state structure of PPDSA at different humidities is needed to better understand the water retention properties of PPDSA. Other sulfonated rigid rod poly(p-phenylene)s have such properties. But, this reference did not show WAXD data at different relative humidities; the environmental humidity was not controlled during the WAXD experiments. The PVC sealing method ensured that the samples were kept at controlled humidities, and reasonable spectra were obtained.

In the WAXD spectra, the intensities and breadths of peak A at different humidities depend on the X-ray acquisition mode: intense and sharp peaks in the transmission mode vs. weak and broad peaks in the reflection mode. A possible reason for weak intensities and broader peaks A in the reflection mode might be that most of chains are oriented relatively perpendicular to the film surface. The d spacing for peak A is a function of relative humidity (relative to lambda; the number of absorbed water molecules per sulfonic acid group) and information about the solid state morphology can be extracted. A plot of the d spacing of peak A versus lambda is shown in FIG. 18. The d spacing changes from 15 to 75% RH are from ˜8 to ˜11 Å, and are proportional to lambda (λ: 4.3 to 8.5) while the d spacing change in the 0˜11% RH does not follow the curve above 15% RH.

The directional dependence of the X and Y chain orientation in the PPDSA films was tested using samples orientations, with the X-ray beam parallel (or perpendicular) to the casting direction. In the transmission mode, peak positions and relative intensities are about the same within the experimental error, so the PPDSA film is reasonably isotropic in the X and Y directions. Since the polydomains are perpendicularly oriented to the surface, the PPDSA film is reasonably isotropic in the X and Y directions. 2-D X-ray spectra and dimensional changes at different humidities support the isotropy finding. Equilibrated films at different relative humidities have only ring in the 2D X-ray spectra and the d spacings agree with those from WAXD. In addition, equilibrated films had an almost isotropic dimensional expansion in the X, Y and Z directions.

In the reflection mode, the positions of peaks C1, C2, D, E and F were almost same, but their intensities varied with the beam direction; the C1 and C2 peaks are more intense than other peaks in the parallel beam direction. However, these directional dependencies for peaks C1, C2, D, E and F require more study.

### Effect of Water Contents on Proton Conductivity of PPDSA

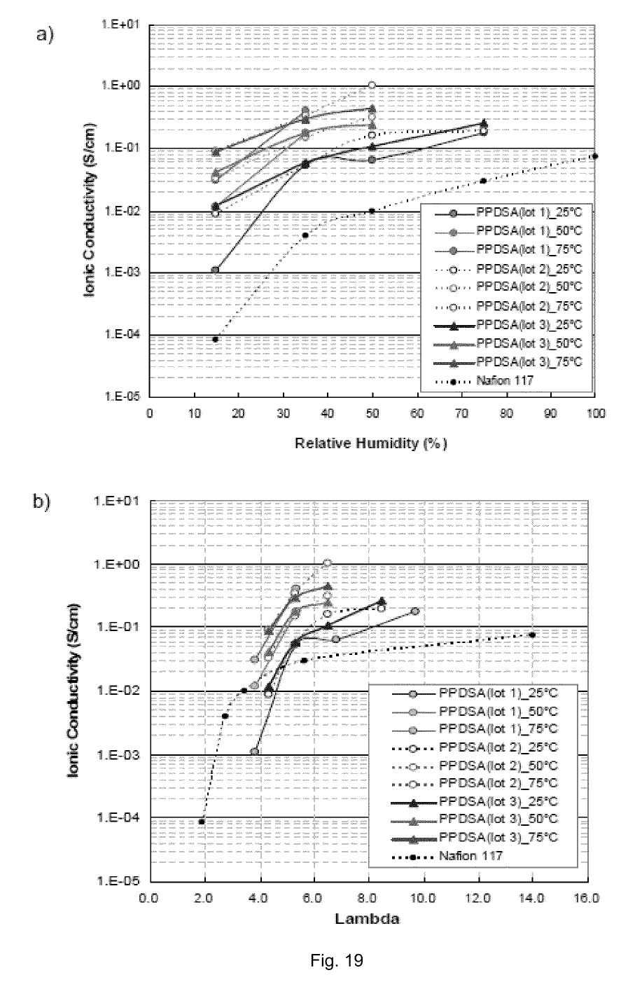

The most important result is that the polymers have higher conductivities at low humidity (15% RH) compared to Nafion 117 (Table 12 and FIG. 19). The conductivities are plotted in terms of the relative humidity and lambda. Lambda might not change much in test temperature range (from 25 to 75° C.) because most of absorbed water can vaporize from 120° C. under lab atmosphere. The proton conductivities of PPDSA (lots 2 and 3) were about 10² times higher than that of Nafion 117 at 15% RH and room temperature, reaching about 0.1 S/cm at 50% RH and room temperature. These results meet the DOE guidelines for high temperature fuel cells. Three main reasons for the high conductivities at low humidity are suggested: 1) the higher lambda (water content) of PPDSA film compared to that of Nafion at the same conditions, 2) high IEC (ion exchange capacity) of PPDSA and 3) the nano-size proton transfer channels within the film.

The first reason is high lambda for PPDSA. Lambda for PPDSA is about two waters higher than those of Nafion 117 between 15 and 75% RH at room temperature. Theoretically, the water molecules in the fuel cell membrane can be considered as the carrier phase in the Grotthuss mechanism (the hopping of hydrogen-bonded proton, H₃O⁺) or the vehicle mechanism (the pure diffusion of hydrated protons, [H⁺ (H₂O)ₙ]). The proton conductivity is proportional to the lambda.

The second reason is high IEC of PPDSA (8.46 meq/g). Xinhuai Ye et al. studied the effect of IEC on the proton conductivity of sulfonated polyimide. They synthesized sulfonated polyimides with different sulfonation degrees. Their IEC values were 2.54, 2.81 and 3.08, and the proton conductivity of these polymers increased with IEC, especially at high temperature (140° C.). In fact, to have high conductivity, IEC is a very important consideration in polymer design.

The nano-size channels (much less than 8-11 Å) due to the hexagonal packing of polymer molecules in the film could also help to increase the conductivity. The absorbed water molecules are partly held by hydrogen bonding with the sulfonic acids. The frozen-in free volume, suggested in previous section, due to the hexagonal packing of the PPDSA backbones helps hold the water molecules efficiently at low humidity. Also, the linear rigid rod structure of PPDSA can decrease the mean-free-path of the mobile ion. No matter whether the H+ mobility is due to the Grotthuss mechanism or the vehicle mechanism, the short distance between the adjacent sulfonic acids and the straight path can increase the proton transport velocity.

PPDSA conductivities are isotropic in the X and Y direction, as shown in FIG. 2.46. This directional independence can be expected from the ring patterns in 2D-Xray spectra and the isotropic dimensional expansion. However, polymer chains are perpendicularly oriented to the surface, as shown in the WAXD spectra using transmission versus reflection data, and through-plane conductivity (in the Z direction) should be the same or higher than in-plane conductivity.

TABLE 12

| | Relative | Conductivity (S/cm) | | | |
|---|---|---|---|---|---|
| Temperature | humidity | PPDSA | | | Nafion |
| (° C.) | (% RH) | Lot 1 | Lot 2 | Lot 3 | 117 |
| 25 | 15 | 1.1E−03 | 8.9E−03 | 1.2E−02 | 8.5E−05 |
| | 35 | 5.5E−02 | 5.3E−02 | 5.8E−02 | 4.0E−03 |
| | 50 | 6.5E−02 | 1.6E−01 | 1.1E−01 | 1.0E−02 |
| | 75 | 1.8E−01 | 1.9E−01 | 2.6E−01 | 3.0E−02 |
| 50 | 15 | 1.2E−02 | 3.3E−02 | 4.2E−02 | |
| | 35 | 1.8E−01 | 1.5E−01 | 1.8E−01 | |
| | 50 | NA | 3.2E−01 | 2.5E−01 | |
| | 75 | NA | NA | NA | |
| 75 | 15 | 3.1E−02 | 9.2E−02 | 8.7E−02 | |
| | 35 | 4.1E−01 | 3.5E−01 | 2.9E−01 | |
| | 50 | NA | 1.0E+00 | 4.5E−01 | |
| | 75 | NA | NA | NA | |

Proton conductivities of different lots of PPDSA films and Nafion 117 at various temperatures and relative humidities. The PPDSA films were cut parallel to the casting direction.

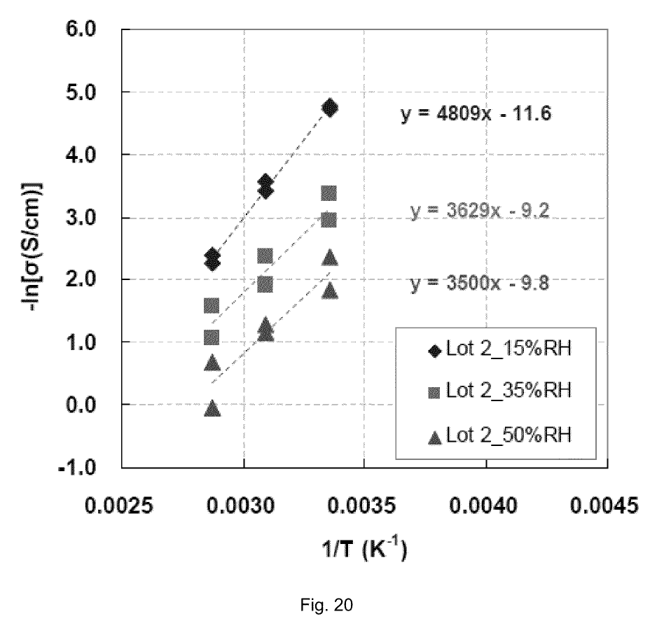

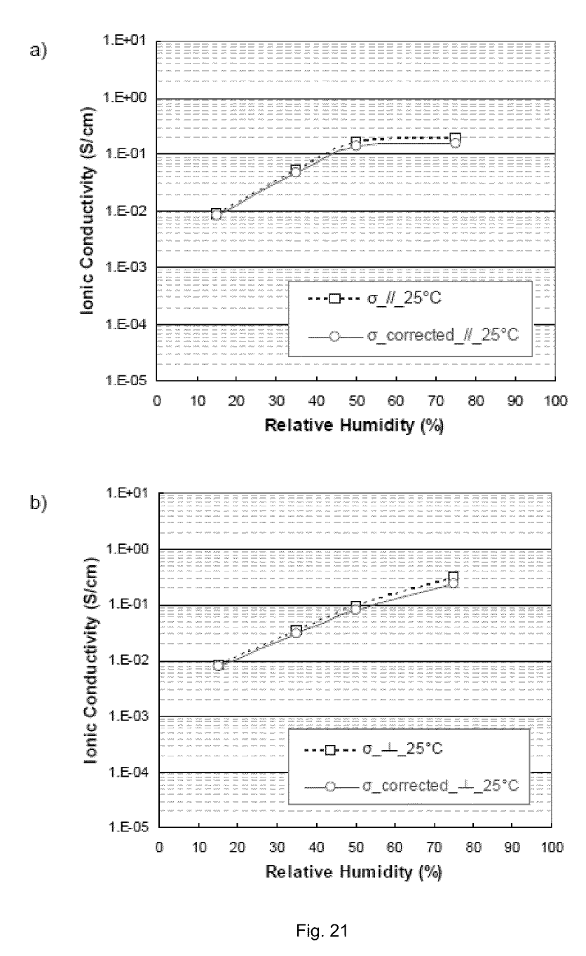

The proton conductivity vs. temperature plots, using PPDSA from different lots with measurements in the X (the measuring direction is parallel to the casting direction) and Y (the measuring direction is parallel to the casting direction) direction at 15˜50% RH, are shown in FIG. 20 and FIG. 21. Because the films lost shape at 75% RH and 75° C., the conductivities for that condition are not included. The temperature dependence of proton conductivity was larger at low humidity for all measurements, as expected.

When the activation energies (Eₐ) the high molecular weight polymers are compared, the high molecular weight polymer's Eₐ is lower. The effect of molecular weight is bigger and the activation energy difference is about 8 kJ/mole as the relative humidity increases to 50% RH

The activation energy of Nafion 117 in liquid water with a lambda of 22.0 is 2.3 kcal/mole (=9.6 kJ/mole). Other values for the Eₐ of Nafion in acidic liquid electrolyte or water were in the range of 10.3˜13.5 kJ/mole. It is well known that proton conduction in Nafion membrane is governed by two mechanisms. One is a proton hopping (Grotthuss) mechanism, and the other is a pure diffusion of hydrated protons, [H⁺(H₂O)ₙ]. It has been suggested that transport of H⁺ by a hopping mechanism contributes more to conduction at high water content, but little protonic hopping is expected at low water content. Thus, the proton conduction in Nafion 117 at high humidity is explained by hopping mechanism (through hydrogen-bonded water molecules that are strongly localized near the sulfonic acid). Lot 3 PPDSA at 50% RH (λ=6.5) and room temperature has an activation energy of 21.4±1.8 kJ/mole, close to that of Nafion (19˜22 kJ/mole) at 50% RH.

The measured and corrected conductivities are shown in FIG. 21. From the conductivities corrected for volume change, it can be seen that the volume corrected conductivities are almost the same as the uncorrected conductivities.

### Intrinsic Conductivity: Proton Conductivity in the Aqueous Phase

To directly compare the proton conductivity of a new membrane with others, we should consider three aspects. The first aspect is that PEM membranes vary greatly in composition and equivalent weight. A second is that morphology affects conductivity greatly at equivalent water content. In addition, fluorocarbon sulfonic acids are much stronger acids than the aromatic sulfonic acids.

Intrinsic conductivities of the polyelectrolyte membrane can be compared if one considers only the aqueous phase in each polymer. This removes the complication of widely differing equivalent weights for different PEMs. It does not compensate for the differing morphologies and acidities, but by removing one complicating factor, it may be easier to understand the influence of the other factors on conductivity.

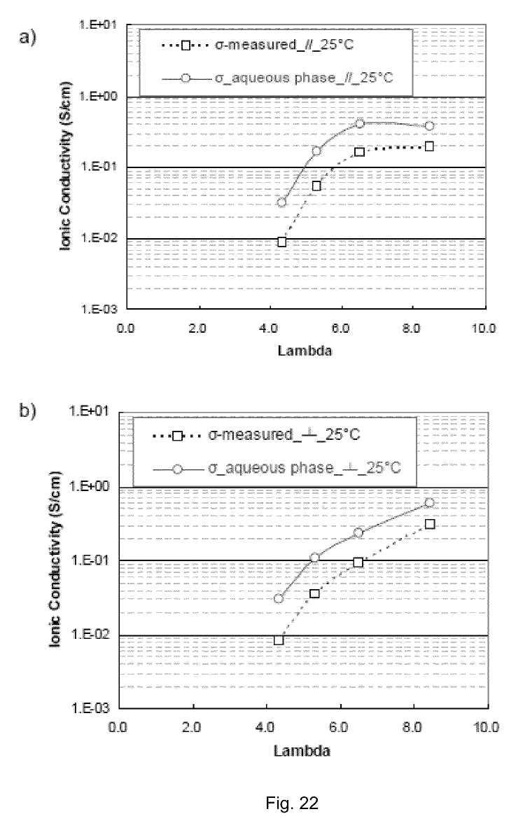

The conductivity in the aqueous phase (intrinsic conductivity) is expressed as the following equation by consideration of the volume change due to absorbing water. The data are shown in FIG. 22.

σ_{aq. phase}=σ_{measured}×(V/V_{water})
where σ_{aq. phase} and σ_{measured} are the conductivity in the aqueous phase and the measured conductivity using impedance measurement; V and V_{water} are the volume of a film after equilibration at a specific humidity and the volume increase after absorbing water.

The intrinsic conductivities for PPDSA at 15% RH are about 5 times higher and above 35% RH, they are about 2 times higher than the measured conductivities. When compared with Nafion and PBPDSA (previously made in our lab), PPDSA has lower intrinsic conductivities from 15 to 35% RH (λ: 4.3 to 5.3) and same order of intrinsic conductivities at and above 50% RH. The possible reason is that the fraction of ionized acid in PPDSA is lower than in Nafion because Nafion is superacid and is almost completely ionized even at λ's of 2 to 3. Above 50% RH (λ˜6.5), the fraction of acid ionized increases and then the intrinsic conductivities PPDSA reach that of Nafion.

### Thermal Stability of PPDSA

PPDSA is expected to have good thermal stability because it is an aromatic polymer. As shown for polyphenylene sulfide (PPS) with a degree of sulfonation, m=2, highly sulfonated polymers have higher thermal stability than polymers with low degrees of sulfonation. The decomposition temperature of highly sulfonated PPS (m=2.0) was 265° C., 125° C. higher than that of PPS (m=0.6) and 75° C. higher than that of perfluorosulfonic acid ionomer (Nafion). This is attributed to the stronger C—S bond strength in PPS (m=2.0) due to the two electron-withdrawing sulfonic acid substituents on one phenyl ring.

PPDSA decomposed at about 304° C., which is 114° C. higher than that of the perfluorosulfonate ionomer (Nafion) decomposition temperature. The first weight loss is due to vaporization of tightly bound water (λ=1.2). This vaporization can be seen in its DSC high temperature scan curve (FIG. 24). The second weight loss is shown in DSC scan curve and is possibly due to decomposition of sulfonic acids. The thermal behavior of PBPDSA was studied using TGA-MS by Litt's group; SO₂ was detected at 245° C. and above, indicating loss of sulfonic acid.

1,4-Dibromo-2,5-benzenedisulfonic acid, DBBDSA was made by sulfonation of 1,4-dibromobenzene with fuming sulfuric acid at 225° C. The chemical structures of DBBDSA-Li (dilithium salt), -Na (disodium salt), -BTMA (benzyltrimethylammonium salt) and -TBP (tetrabutylphosphonium salt) were characterized by ¹H-, ¹³C-NMR and FT-IR. The maximum yield of desired product was about 35 to 38% in both small and large scale reactions.

Using the new monomer, PPDSA, [poly(p-phenylene-2,5-disulfonic acid)] were made using the copper mediated Ullmann coupling reaction. Based on the viscosities of several salt forms of PPP in different solvents, reaction conditions needed to produce high molecular weight polymer were found. Higher molecular weight PPDSA was obtained (reduced viscosity: 0.671 dL/g at 0.202 g/dL in D₂O at 35° C.) from the reaction of DBBDSA-Li in dried DMF (0.05 mole/L) at 135° C. The chemical structure was studied by ¹H- and ¹³C-NMR. ¹H-NMR spectra showed that as the molecular weight of polymer increased, all peaks became broader (larger FWHH) and the relative area of peaks near 7.65 ppm noticeably decreased. The number average of degree of polymerization of the polymer (lot 3, high molecular weight polymer) was 142 by calculation using the area ratio of deconvoluted peak areas. The structure of PPP was characterized by ¹³C-NMR and confirmed the coupling between monomers at 1 and 4 positions.

From rheometric measurements, PPDSA solutions (38.51 g/dL) had shear dependent viscosity and two regions (shear thinning and Newtonian plateau) in its viscosity-shear rate plot as expected from rigid rod polymer structures.

GPC was used to calculate the molecular weights of the polymers relative to PS standards. However, the elution time of the polymer and the monomer were almost same. In addition, GPC chromatograms and elution times were greatly affected by temperature, polymer concentration and salt concentration. These made an interpretation of GPC chromatograms difficult.

The solution properties were those expected from a linear rigid rod polymer. Reduced viscosity showed an upturn as concentration decreased and this behavior was not affected by the presence of salt in the solution. PPDSA aqueous solutions showed shear thinning, which is characteristic of linear rigid rod polymers. A modified Huggins equation was applied to study the viscosity behavior of PPDSA, but more study is needed to understand the system fully.

Membrane properties of PPDSA were characterized in terms of water content. PPDSA absorbed about two waters per sulfonic acid more than Nafion from 15 to 75% RH at room temperature. It absorbed more water at a given relative humidity than other aromatic sulfonic acid polyelectrolytes. DSC high and low temperatures scanning curves showed that absorbed water molecules (λ˜9 at 75% RH) did not freeze after cooling to −50° C. There were two vaporization endotherms on heating; the lower one was at about 120˜130° C. and the higher one was about 150˜160° C. These could be assigned to strongly bound water with different binding strengths. TGA result showed that the dried polymer had about one water molecule per sulfonic acid. The polymer started decomposing at about 304° C. This is excellent stability compared to other sulfonic acid polyelectrolytes.

High water content and strong binding power were related to the frozen-in free volume in PPDSA. The frozen-in free volume at different relative humidities was studied using macroscopic and microscopic methods, dimensional/weight changes measurements and X-ray (WAXD and 2D X-ray).

Dimensional/weight change measurements showed that the PPDSA molar volume did not increase proportionally with the change of its molar weight. From X-ray results in the transmission mode, the long spacing increase from 8 to 11 Å as the relative humidity increased from 0 to 75%. WAXD reflection spectra showed peaks only at higher angles (smaller d spacings) that did not vary with relative humidity. These are probably related to the sulfonic acid organization around the backbone. The long spacing was barely visible in these spectra, showing that there were very few domains with chain axes parallel to the film surface. Flat plate X-ray scans showed only the long spacing; this was a complete ring. This implies that the nematic domains were organized with axes from ˜45 to 90° to the film surface. When a polarizing optical microscope was used to study PPDSA, it was birefringent over the whole relative humidity range. Local domain orientation would be observed even at 15% RH and domain size increased as the relative humidity increased.

To study a relationship between the inter-chain distance and lambda at different humidities, a hexagonal packing model was proposed and verified using micro- and macroscopic data. Based on the results from the model study, PPDSA had a frozen-in free volume about four water molecules at λ=0 can be filled with water. The sharp increase of lambda from 0 to 15% RH was possibly explained by this free volume. The calculated density of water using this model was 1.23 g/cc. In addition, permanent nano-size proton conducting channels can be formed in the hexagonal structure and these nano-size channels can provide high water binding ability and high proton conductivity at low humidity.

The water content affects the proton conductivity and mechanical properties. PPDSA had outstanding proton conductivity when compared to other membrane materials; 0.01 S/cm at 15% RH and room temperature (which is 10² times higher than that of Nafion) and 0.1 S/cm at 15% RH and 75° C. Conductivity was above 0.1 S/cm at 75% RH and room temperature. The conductivity activation energy of PPDSA at ˜6.5 was 21.4±1.8 kJ/mole. Even if the volume changes were considered, the PPDSA conductivities did not change much. The PPDSA intrinsic conductivities were affected the fraction of acid ionized. The conductivities were lower than Nafion at low lambda and almost same as those of Nafion above λ=6.5.

The low modulus of humidified PPDSA was explained as due to the by plasticizing effect of the absorbed water and the perpendicular orientation of polymer. Film humidified at 35% RH had a very lower modulus (31.4 MPa).

What has been described above includes examples and implementations of the present invention. Because it is not possible to describe every conceivable combination of components, circuitry or methodologies for purposes of describing the present invention, one of ordinary skill in the art will recognize that many further combinations and permutations of the present invention are possible. Accordingly, the present invention is intended to embrace all such alterations, modifications and variations that fall within the spirit and scope of the appended claims. All references, publications, and patents cited in the application are incorporated by reference in their entirety.

Having described the invention, the following is claimed:

1. A rigid, rod liquid crystal polymer, comprising a main chain that includes a poly(phenylene disulfonic acid).

2. The polymer of claim 1, being synthesized via an Ullmann coupling reaction from a dihalo-benzene disulfonic acid monomer.

3. The polymer of claim 1, the poly(phenylene disulfonic acid) comprising a phenylene disulfonic acid repeating unit, the phenylene disulfonic acid repeating unit forming a substantial portion of a main chain of the polymer.

4. The polymer of claim 1, including at least one side group extending from the main polymer chain, the side group comprising at least one of bulky side groups, angled groups, or cross-linkable groups.

5. The polymer of claim 4, the bulky side groups, angled groups, cross-linkable groups rendering the polymer substantially water insoluble.

6. The polymer of claim 1, including the following structure: 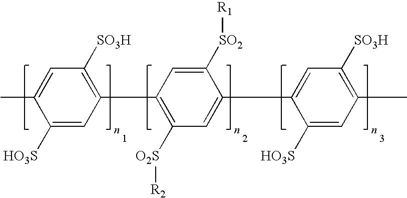
where R₁ and/or R₂ can each comprise a hydroxyl, a bulky group and/or a cross-linkable group, and at least one R₁ or R₂ is not a hydroxyl.

7. The polymer of claim 1, comprising a random, graded or block repeating units.

8. A liquid crystal polymer comprising the following formula 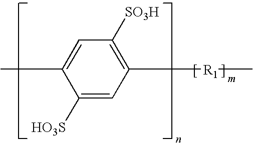
wherein R₁ comprises a non-polar aryl group, the non-polar group including at least one of a bulky, angled, or cross-linkable repeating unit and where the ratio of n to m is at least about 1 to 1.

9. A method of forming a rigid, rod liquid crystal polymer;
polymerizing via an Ullmann coupling reaction a dihaloaryl disulfonic acid monomer to form a poly(phenylene disulfonic acid).

10. The method of claim 9, the dihaloaryl disulfonic acid monomer comprising a 1,4′-dihalo-2,4′-benzenedisulfonic acid.

11. The method of claim 11, further comprising chemically modifying at least one sulfonic acid group of the polymer to incorporate at least one of bulky groups or cross-linkable groups.

12. A method of forming a liquid crystal polymer comprising:
copolymerizing a dihaloaryl disulfonic acid monomer and at least one non-polar aryl group comonomer, the comonomer including at least one of bulky, angled, or cross-linkable groups.

13. The method of claim 12, the dihaloaryl disulfonic acid monomer comprising a dihalobenzene disulfonic acid monomer.
